(19) United States
(12) Patent Application Publication
(10) Pub. No.: US 2022/0343713 A1
(43) Pub. Date: Oct. 27, 2022

(54) Machine Core and Multi-Currency Allocation Assembly Line Thereof

(71) Applicant: WEIRONG TECHNOLOGY CORPORATION, Wenzhou, Zhejiang Province (CN)

(72) Inventors: Wei WEI, Wenzhou (CN); Zhen FANG, Wenzhou (CN); Debei CHEN, Wenzhou (CN); Wei GUAN, Wenzhou (CN); Yaozhun CAI, Wenzhou (CN); Baotao NI, Wenzhou (CN); Ronghai LI, Wenzhou (CN); Xiaolan WEI, Wenzhou (CN); Maoxing WANG, Wenzhou (CN)

(21) Appl. No.: 17/640,811

(22) PCT Filed: Sep. 23, 2020
(86) PCT No.: PCT/CN2020/116999

§ 371 Date: Mar. 5, 2022

(30) Foreign Application Priority Data
Oct. 10, 2019 (CN) 2019109598916

(51) Int. Cl. G07D 11/13; G07D 11/50; B65H 5/02; B65H 29/14; B65B 25/14; B65B 35/50

(52) U.S. Cl. CPC G07D 11/13; G07D 11/50; B65H 5/023; B65H 29/14; B65B 25/14; B65B 35/50; G07D 2211/00; B65H 2701/1912

(57) ABSTRACT

A multi-currency allocation assembly line includes a machine core module, a plastic packaging module, a sorting assembly line, and a manipulator. The machine core module is used for storing banknotes, and outputting banknotes into a banknote receiving funnel according to a system instruction. Among the machine cores in an array, the machine cores respectively store different banknotes, and the banknotes output by the different machine cores are then respectively conveyed, by means of the manipulator, to the plastic packaging module for plastic packaging and are then conveyed to the sorting assembly line, so as to complete banknote allocation, packaging and sorting in one step, thereby greatly increasing the banknote allocation efficiency and minimizing manual errors during manual operation.

### BACKGROUND OF THE PRESENT INVENTION

### Field of Invention

The present invention relates to financial equipment, and more particularly, to a machine core and multi-currency allocation assembly line thereof.

### Description of Related Arts

When a financial institution performs banknote allocation of various kinds of foreign banknotes, it is generally necessary to take out the corresponding banknotes from each banknote box according to the demand quantity, and then consolidate, pack, and convey the banknotes. At present, for the banknote dispensing of multiple currencies, different small banknote dispensing machines are the general choice. Different banknote dispensing machines are respectively utilized for banknote allocation and then the banknotes are consolidated, counted, and finally, plastic packaged and transported. Obviously, this practice has quite fallen behind, and its efficiency is extremely low. Because manual selection of the banknote allocation machines is required, manual errors can easily take place, such as a wrong selection of the banknote or banknote quantity error, which will be a significant accident in the banknote dispensing process, and the risks of such accidents are very high if manual operations are utilized.

Accordingly, the present invention provides a multi-currency allocation assembly line by the inventors, which performs flow line operation by means of instructions, so that banknotes in different banknote allocation machine cores can be respectively output to the sorting assembly line, so that errors caused by manual operation can be avoided, and the efficiency can be effectively enhanced.

### SUMMARY OF THE PRESENT INVENTION

In view of the above drawbacks of the prior art, technical problems to be solved by the present invention include providing a machine core and multi-currency allocation assembly line thereof.

In order for achieving the above and other objects, the present invention provides a machine core, which comprises two machine core side plates, two machine core end plates, a machine core lid mounted at a top of the two machine core side plates, wherein the two machine core side plates and the two machine core side plates are side by side connected respectively, so as to form four side walls of the machine core;

the machine core lid having a machine core lid side plate and a machine core lid end plate arranged thereon, wherein a side of the machine core lid side plate is hingedly jointed with one of the machine core side plate through a hinge, wherein the machine core lid end plate has a machine core lock sliding groove penetratedly formed therein, wherein through the machine core lock sliding groove, a fourth machine core lock rod is slidably assembled therein, wherein the fourth machine core lock rod penetrates through two sides of the machine core lock sliding groove to be assembled and affixed with a machine core lock limiting ring respectively;

the fourth machine core lock rod being further assembled and affixed with an end of a first machine core lock plate, wherein the other end of the first machine core lock plate is hingedly jointed with the machine core end plate through a third machine core lock rod, wherein the third machine core lock rod is positioned away from a side of a hinge joint of the third machine core lock rod and the machine core lid;

the core lid end plate being further hinged to an end of a second machine core lock plate through a second machine core lock shaft, wherein the other end of the second machine core lock plate has a machine core lock groove, wherein a first machine core lock rod is coupled and assembled in the machine core lock groove, wherein the first machine core lock rod is affixed on the machine core end plate;

the second machine core lock plate being further assembled and affixed with an end of a machine core extension spring, wherein the other end of the machine core extension spring is assembled and affixed with a fifth machine core lock rod, wherein the fifth machine core lock rod is affixed on the core lid end plate.

Preferably, the machine core extension spring and the machine core lock groove are respectively disposed at two ends of the second machine core lock plate located at a second machine core lock rod.

Preferably, the machine core lock sliding groove has a plurality of limiting slots formed therein, allowing the fourth machine core lock rod to be coupled in the limiting slots.

Preferably, the third machine core lock rod comprises a machine core torsion spring sleeved thereon, wherein the machine core torsion spring provides a resilience to hinder the first machine core lock plate from rotating in a direction away from the first machine core lock plate.

Preferably, each of the machine core lid and the machine core side plates comprises an upper closing detection shell and a lower closing detection shell arranged thereon, wherein the upper closing detection shell has an upper closing sliding groove and an upper closing sliding block is slidably mounted in the upper closing sliding groove, wherein the upper closing sliding block is affixed at one end of a closing sliding rod, wherein the other end of the closing sliding rod penetrates through an upper closing limiting ring to be assembled and affixed with a closing detection piece, wherein the upper closing limiting ring is affixed in the upper closing sliding groove;

a lower closing limiting ring being mounted between the closing sliding rod located between the upper closing limiting ring and the closing detection piece, wherein the closing sliding rod comprises a closing pressure spring sleeved on the portion thereof between the upper closing limiting ring and the lower closing limiting ring;

the lower closing detection shell having a closing detection groove provided therein and a closing detection sensor being mounted on the inner wall of the closing detection groove, wherein the closing detection sensor is a photoelectric sensor, which signal is the same as the first limiting sensor or the second limiting sensor, wherein the closing detection groove has a closing limiting table affixed at the bottom thereof, wherein the closing limiting table is attached to the bottom surface of the closing sliding rod, so as to limit the closing sliding rod.

Preferably, the machine core has a hollow machine core mounting cavity provided internally and comprises a plurality of banknote boxes mounted in the machine core mounting cavity, wherein the banknote outputting mechanism of each of the banknote boxes is respectively driven by a first machine core motor;

a first machine core belt, a second machine core belt, and a third machine core belt being respectively provided and mounted under the machine core lid and above the banknote boxes, wherein the second machine core belt is located at the banknote outlet of the machine core above the banknote receiving wheel, so as to coordinate with the first machine core belt to clamp and convey the banknotes, wherein the first machine core belt, the second machine core belt, and the third machine core belt are respectively wound around a plurality of first machine core belt pulleys, second machine core belt pulleys, and third machine core belt pulleys to form a belt transmission mechanism, wherein the first machine core belt pulleys, the second machine core belt pulleys, and the third machine core belt pulleys are respectively mounted on a first machine core shaft, a second machine core shaft or a third machine core shaft correspondingly thereto, wherein the first machine core shaft, the second machine core shaft, and the third machine core shaft are respectively rotatably assembled with the machine core lid side plate in a circumferential rotation manner;

one of the first machine core shaft, the second machine core shaft, and the third machine core shaft penetrates through one of the machine core lid side plate to be connected with the output shafts of three second machine core electrical motors respectively through a coupler.

Preferably, a fourth machine core belt and a fifth machine core belt are arranged below a portion of the first machine core belt and the third machine core belt located inside of the machine core mounting cavity to coordinate thereto for clamping and conveying banknotes, wherein the fourth machine core belt and the fifth machine core belt respectively surround around a fourth machine core belt pulley and a fifth machine core belt pulley to form a belt transmission mechanism, wherein the fourth machine core belt pulley and the fifth machine core belt pulley are respectively mounted on a fourth machine core shaft and a fifth machine core shaft, wherein the two ends of the fourth machine core shaft and the fifth machine core shaft are respectively circumferentially rotatably assembled on the machine core lid side plate.

The present invention also discloses a multi-currency allocation assembly line, which utilizes the above machine core.

Preferably, it further comprises a machine core module, a plastic packaging module, a sorting assembly line, and a manipulator, wherein the machine core module is adapted for storing banknotes and outputting banknotes to the banknote receiving funnel according to the system instruction;

the manipulator being adapted for conveying the banknotes in the banknote receiving funnel to the plastic-package feeding mechanism of the plastic packaging module, wherein the plastic packaging machine plastic packages and outputs the stacked banknotes to a stacking mechanism, wherein the stacking mechanism stacks and outputs the same type of banknotes to a sorting and conveying mechanism of the sorting assembly line from a banknote outlet, wherein a side surface of the sorting and conveying mechanism communicates with a sorting frame through an inclined sorting plate, wherein the machine core module comprises a machine core housing and a machine core framework, wherein the machine core housing is mounted outside the machine core framework, wherein each of the machine cores is installed in the machine core framework, wherein the machine core respectively has a banknote receiving funnel installed at each of the banknote outlets respectively, wherein the banknote receiving funnel is affixed on a banknote receiving supporting plate, wherein the banknote receiving supporting plate is affixed on the machine core framework, wherein the machine core framework further comprises a sliding rail mounting plate mounted on the bottom thereof, wherein the sliding rail mounting plate comprises at least one sliding rail mounted thereon, wherein the sliding rail is engaged and slidably assembled with a supporting arm sliding block on the manipulator.

Preferably, the manipulator comprises a first support arm, a second support arm, a third support arm, a first arm claw, and a second arm claw, wherein the first support arm is configured to drive the second support arm and the third support arm to move in a length direction thereof, wherein the second support arm is configured to drive the third support arm to move in the length direction thereof, wherein the first arm claw and the second arm claw are respectively installed on the third support arm;

the first support arm comprising a first supporting arm cover mounted at the top thereof, a supporting arm bottom plate mounted at a bottom thereof, and a supporting arm reinforcing plate affixed between a top side of the supporting arm bottom plate and a side face of the first support arm, wherein the supporting arm bottom plate comprises a traveling motor affixed thereon, wherein a traveling output shaft of the traveling motor penetrates out of the supporting arm bottom plate to be assembled and affixed with a traveling gear, wherein the supporting arm sliding block is engaged and slidably assembled with the sliding rail, wherein the traveling gear is meshed with a traveling rack affixed on the sliding rail mounting plate so as to form a gear rack transmission mechanism;

the first support arm comprising a circumferentially rotatable first support arm screw rod mounted therein, wherein an end of the first supporting arm screw rod is rotatably assembled with the supporting arm bottom plate, and the other end of the first supporting arm screw rod penetrates out of the first supporting arm to enter the first supporting arm cover to be assembled and affixed with a first second supporting arm belt pulley, wherein the first second supporting arm belt pulley is connected with a first first supporting arm belt pulley through a first supporting arm belt so as to form a belt transmission mechanism, wherein the first first supporting arm belt pulley is mounted on an output shaft of a supporting arm lifting motor, wherein the supporting arm lifting motor is affixed on the first supporting arm, wherein the first support arm screw rod and a supporting arm lifting sliding plate are assembled through threads, wherein the supporting arm lifting sliding plate is engaged and vertical slidably assembled with the first supporting arm;

the second support arm being affixed on the supporting arm lifting sliding plate, wherein the second support arm comprises a second support arm cover mounted on an end thereof and a second support arm screw rod mounted inside thereof, wherein an end of the second support arm screw rod is rotatably assembled in the second support arm with the end thereof away from the second support arm cover, while the other end of the second support arm screw rod penetrates out of the second support arm cover to enter the second support arm cover to be assembled and affixed with a second first support arm belt pulley, wherein the second first belt pulley is connected with the second first support arm belt pulley through a second support arm belt to form a belt transmission mechanism, wherein the second first supporting arm belt pulley is mounted on an output shaft of a supporting arm lateral movement motor, wherein the supporting arm lateral movement motor is affixed on the second supporting arm;

the second support arm screw rod and a supporting arm lateral movement sliding plate being assembled through threads, wherein the supporting arm lateral movement sliding plate is coupled and slidably assembled with the outer wall of the second supporting arm, wherein the supporting arm lateral movement sliding plate comprises a supporting arm hinge frame affixed thereon;

the supporting arm hinge frame comprising a supporting arm rotating motor installed thereon, wherein an output shaft of the supporting arm rotating motor is assembled and affixed with an end of the second arm claw and the third supporting arm through a coupler and a supporting arm hinge shaft, wherein the third support arm comprises a third supporting arm screw rod mounted inside thereof, wherein an end of the third supporting arm screw rod is rotatably assembled with the second arm claw, while the other end of the third supporting arm screw rod passes through the third supporting arm to enter a third supporting arm cover to be assembled and affixed with a third second supporting arm belt pulley, wherein the third supporting arm cover is mounted on the third supporting arm and the third second supporting arm belt pulley is connected with a third first supporting arm belt pulley through a third supporting arm belt so as to form a belt transmission mechanism, wherein the third first supporting arm belt pulley is affixed on the output shaft of a clamping motor, wherein the clamping motor is affixed on the third supporting arm, wherein the third supporting arm screw rod and an end of the first arm claw are screwed and assembled, wherein the end of the first arm claw is buckled in an adjustment sliding groove of the third support arm.

Benefits and advantages of the present invention include:

1. The present invention utilizes a plurality of machine cores in an array, wherein each of the machine cores stores different banknotes and the banknotes output by the different machine cores are then respectively conveyed by means of the manipulator, to the plastic packaging module for plastic packaging and are then conveyed to the sorting assembly line, so as to complete banknote allocation, packaging and sorting in one step, thereby greatly increasing the banknote allocation efficiency, wherein because the banknote allocation instructions are made and controlled through industrial computer, manual errors during manual operation can be minimized.

2. The machine core of the present invention allows a plurality of banknote boxes to be installed therein the at a time, and banknotes in the banknote boxes may be respectively conveyed into the banknote receiving funnels corresponding thereto, thereby completing banknote dispensing and allocation. This design avoids the error caused by manual selection of the banknote allocation machine, and because it allows multiple banknote boxes to be placed at a time, the capacity thereof also meets the requirements of mass banknote dispensing.

3. The manipulator of the present invention allows the banknotes input into the banknote receiving funnel to be grasped and conveyed, so that the banknotes can be consolidated and conveyed to the plastic packaging module for plastic packaging and packaging, so as to allow unified management, and enhance efficiency.

4. The plastic packaging module of the present invention can achieve plastic packaging, stacking, and outputting of banknotes, thereby replacing manual plastic packaging and packaging, so as to greatly enhance the efficiency.

5. The stacking mechanism of the present invention can achieve stacking of stacked banknotes, thereby performing consolidated output so as to facilitate sorting in later stage.

### BRIEF DESCRIPTION OF THE DRAWINGS

FIGS. 1-4 are perspective views illustrating structures according to the present invention.

FIG. 5 is a perspective view of a machine core module according to the present invention.

FIG. 6 is a perspective view of a machine core and banknote receiving funnel according to the present invention.

FIGS. 7-17 are perspective views of the banknote receiving funnel according to the present invention. Here, FIGS. 10, 11, and 12 are respectively sectional views of A-A, B-B, and C-C of FIG. 9.

FIGS. 18-26 are perspective views illustrating the machine core according to the present invention. Here, FIG. 26 is a perspective view of a sensing unit.

FIGS. 27-34 are perspective views illustrating a manipulator according to the present invention. Here, FIG. 30 is a sectional view of the first support arm in the sectional direction, FIG. 31 is a sectional view at the position of the first arm claw, FIG. 32 is a sectional view at the position of the second support arm, and FIG. 34 is a sectional view at the position of the third support arm.

FIGS. 35-36 are perspective views illustrating a plastic packaging module according to the present invention.

FIG. 37 is a perspective view illustrating a plastic packaging machine according to the present invention.

FIGS. 38-40 are perspective views illustrating a stacking mechanism according to the present invention.

### DETAILED DESCRIPTION OF THE PREFERRED EMBODIMENT

The technical solutions of the embodiments of the present invention will be described more fully hereinafter with reference to the accompanying drawings of embodiments of the invention.

In the description of the invention, it is to be understood that, the term “upper,” “lower,” “front,” “rear,” “left,” “right,” “top,” “bottom,” “inner,” “outer,” etc., are based on the orientation or positional relationship shown in the figures, but are merely intended to facilitate the description of the present invention and the simplified description, rather than to indicate or imply that the indicated device or element must have a particular orientation, constructed and operative in a particular orientation, and therefore not to be construed as a limitation of the present invention.

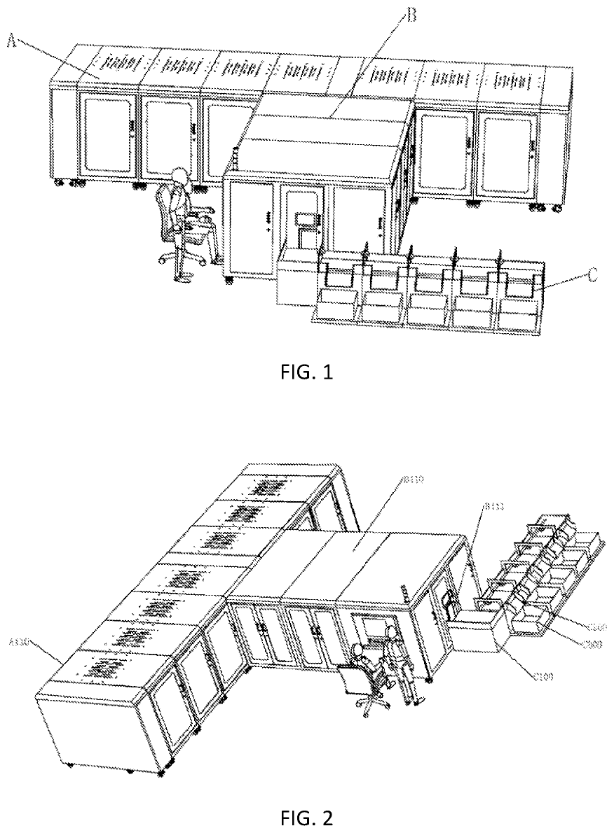

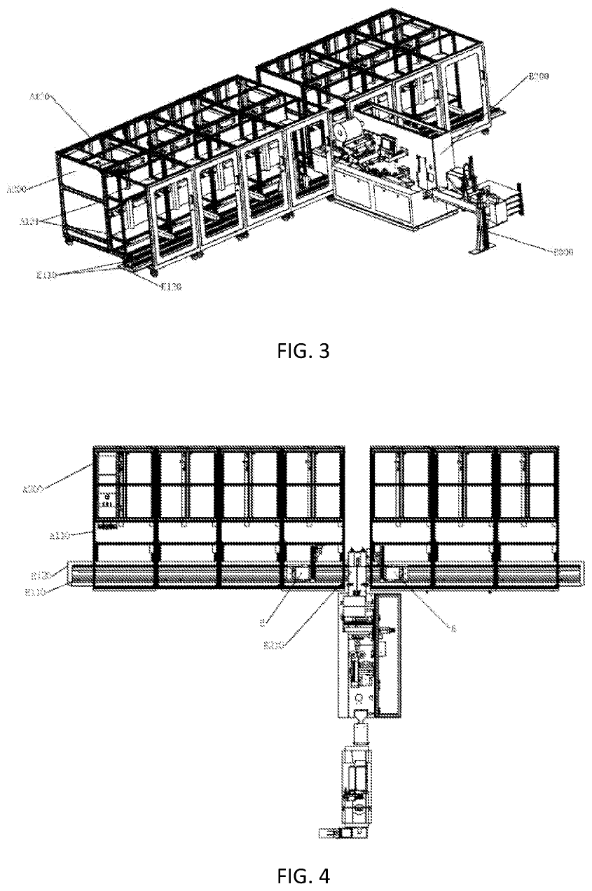

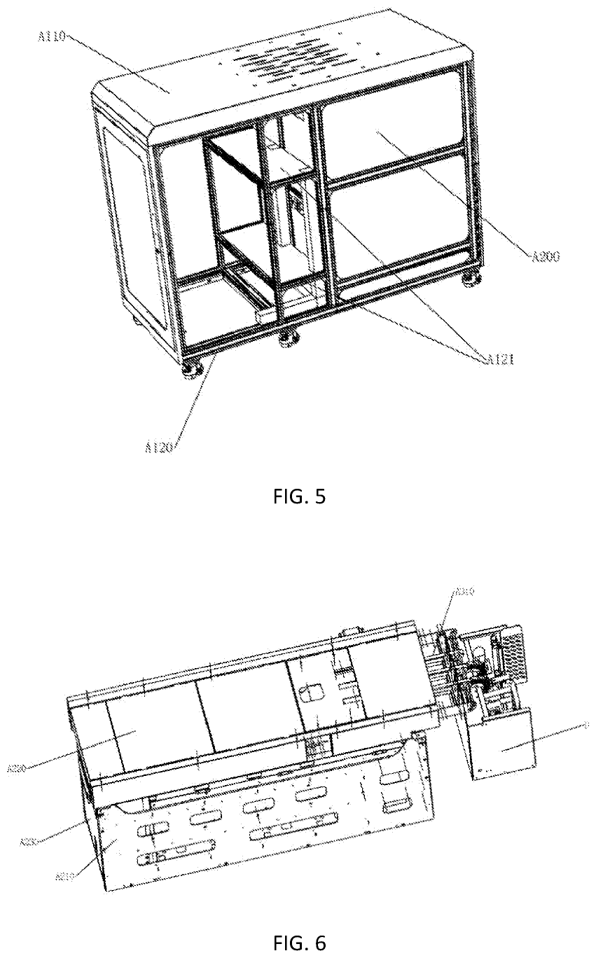

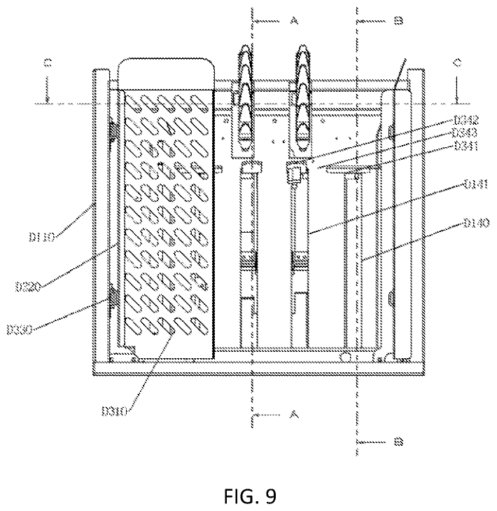

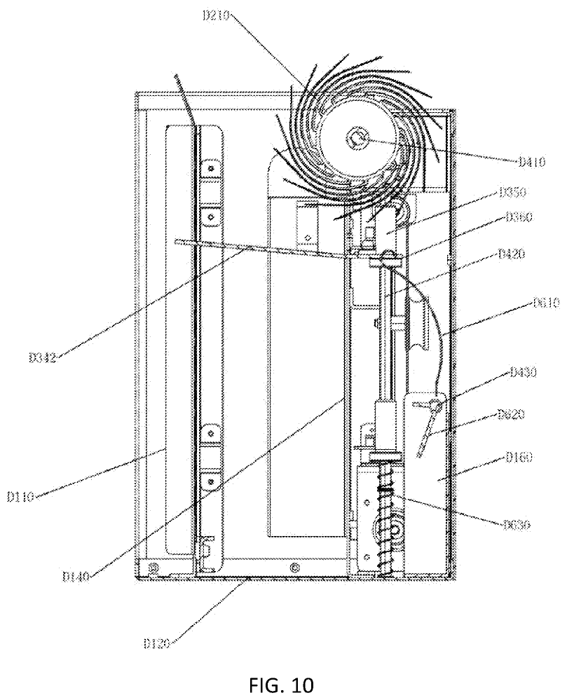

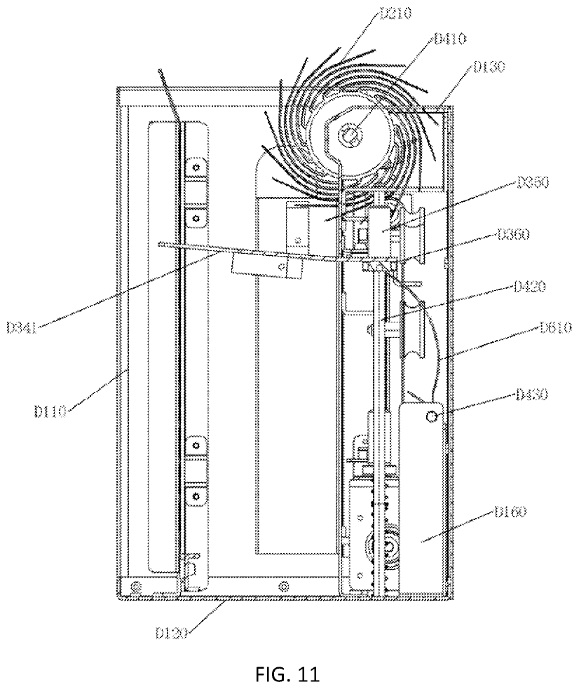

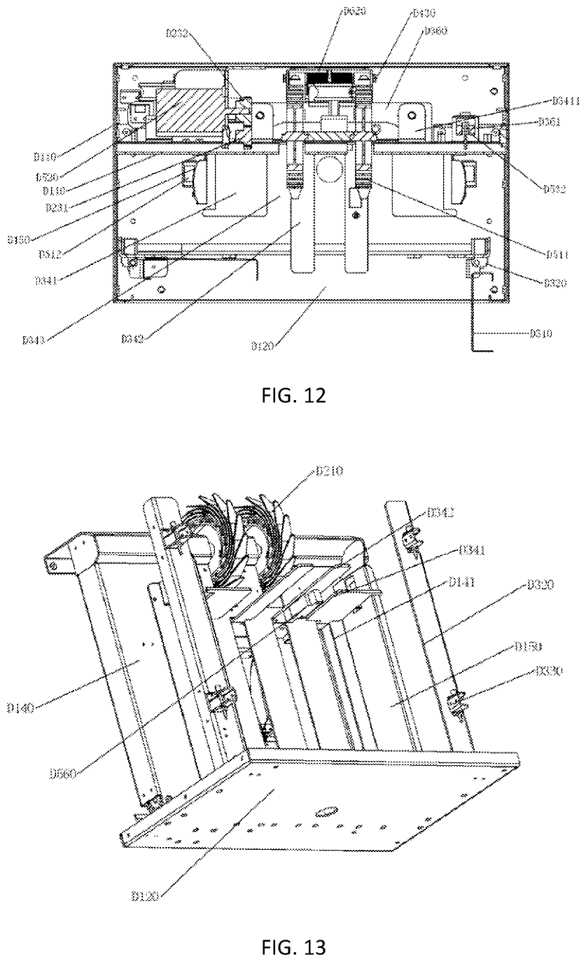

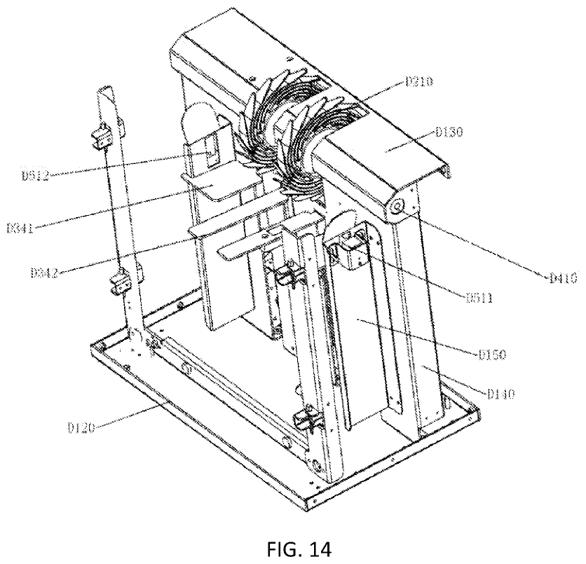

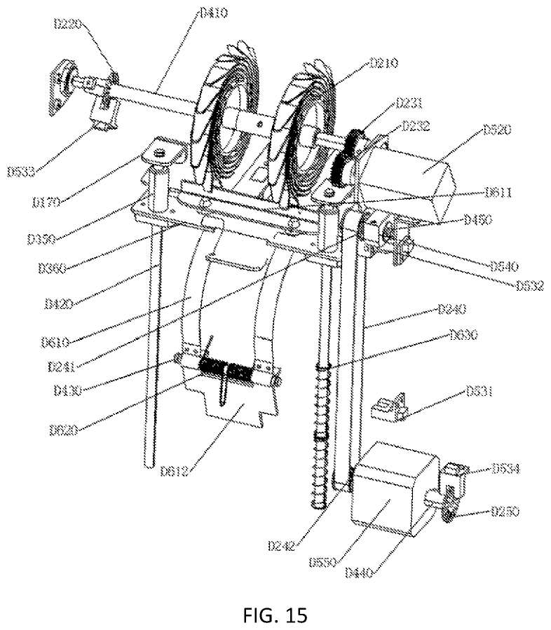

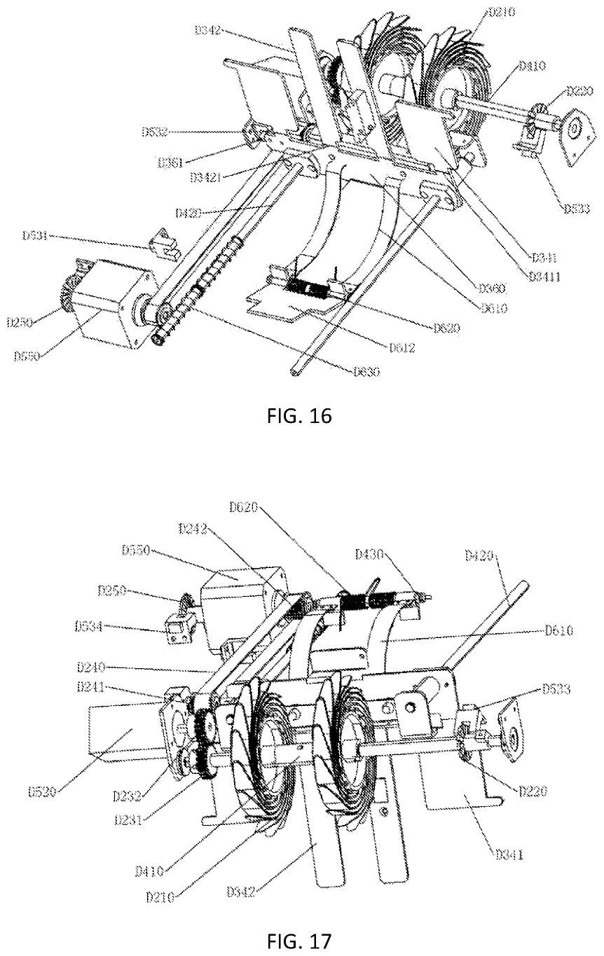

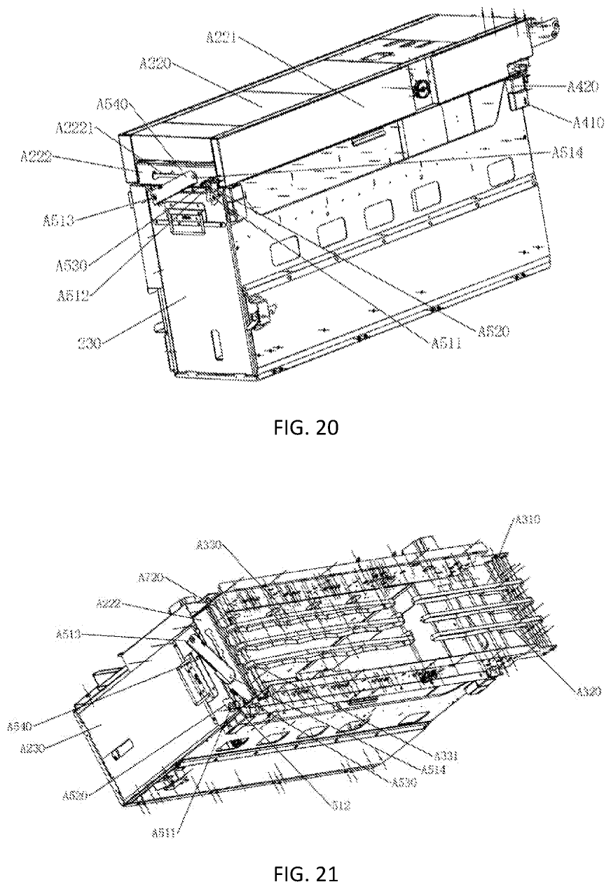

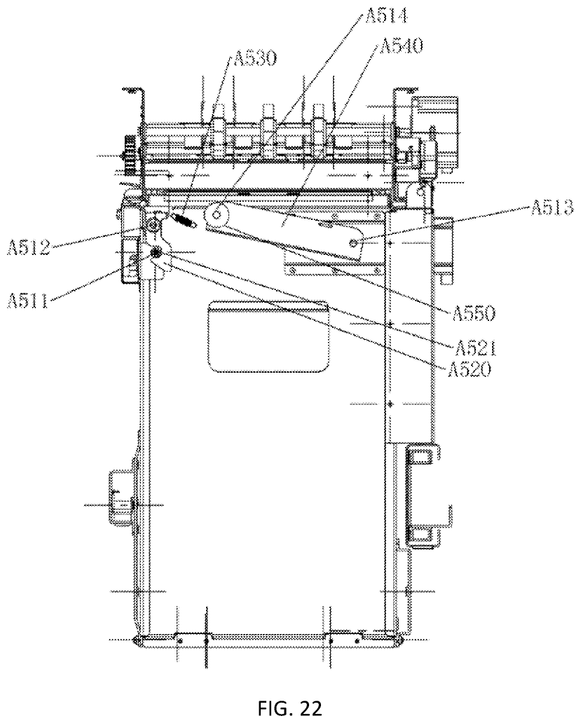

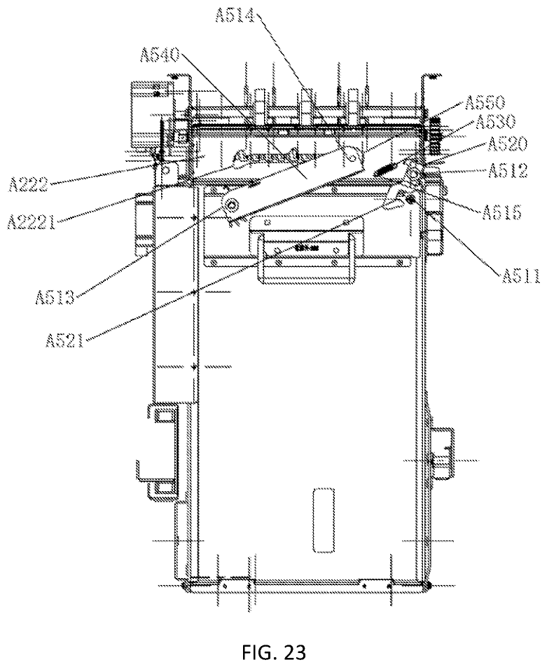

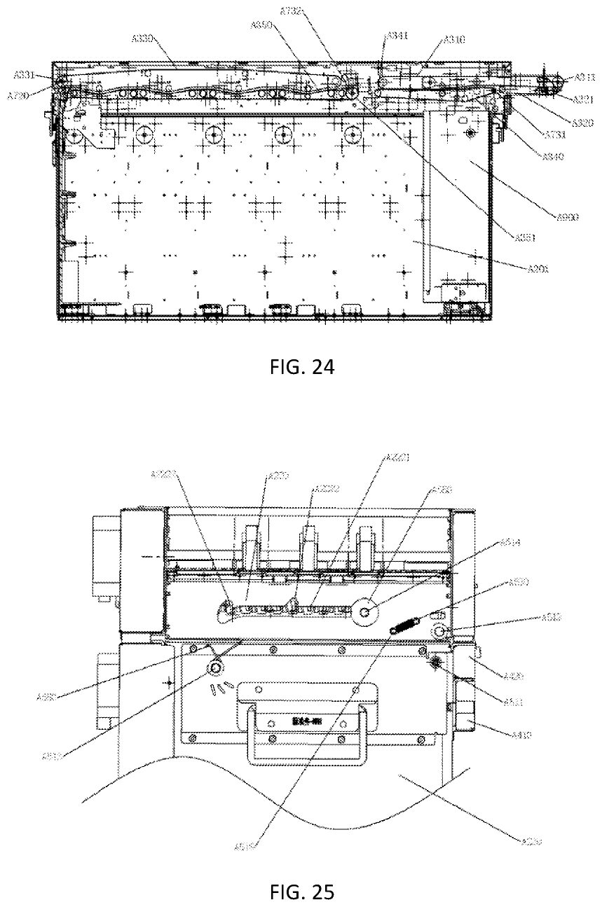

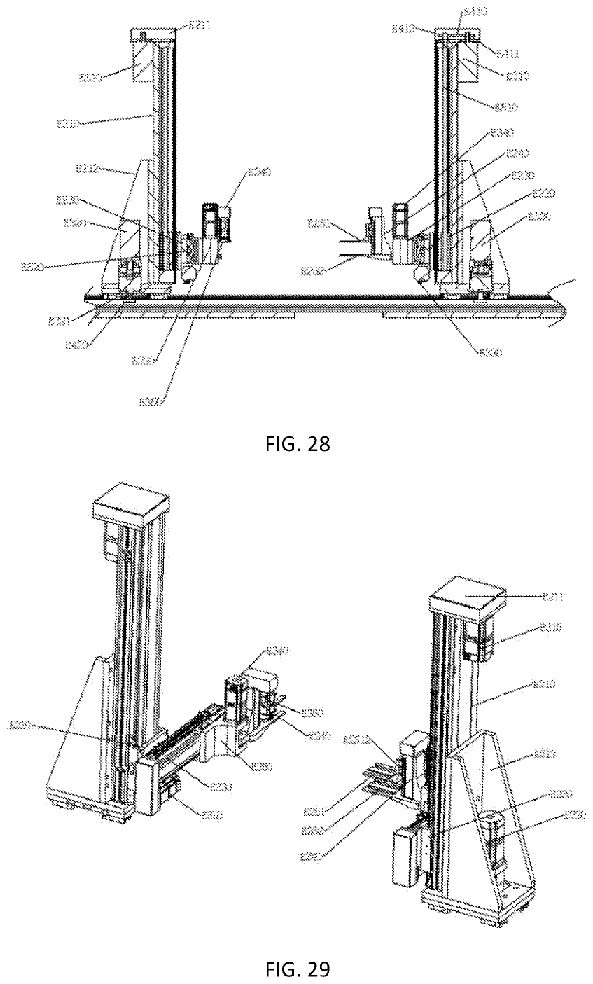

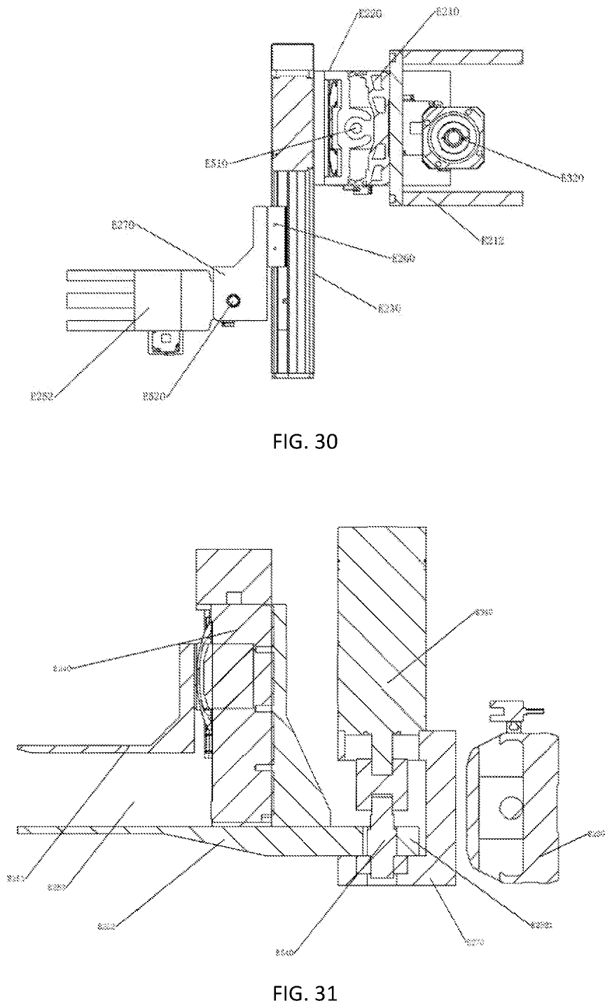

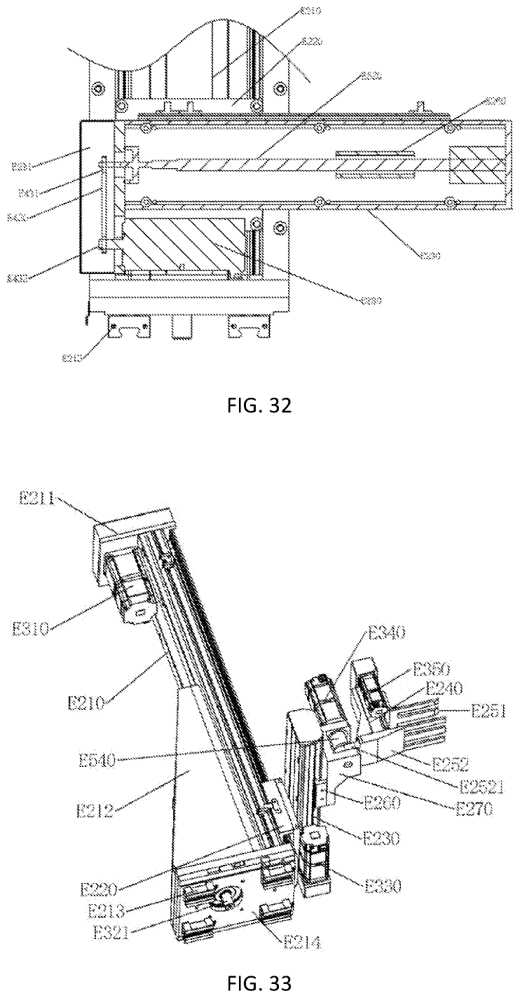

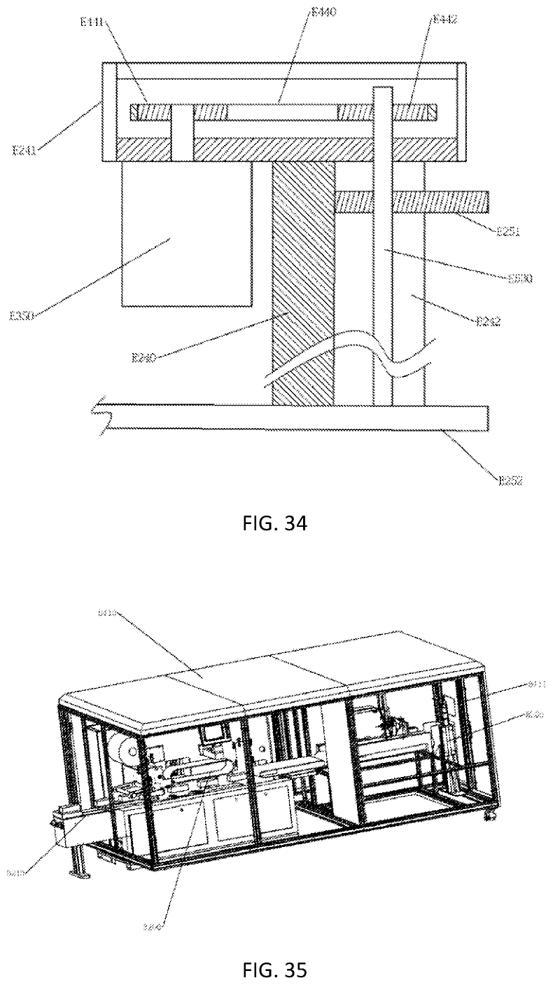

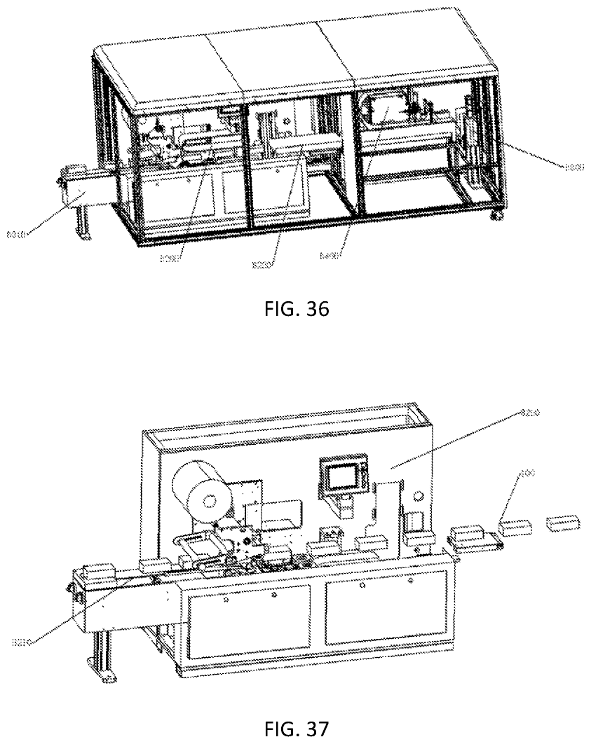

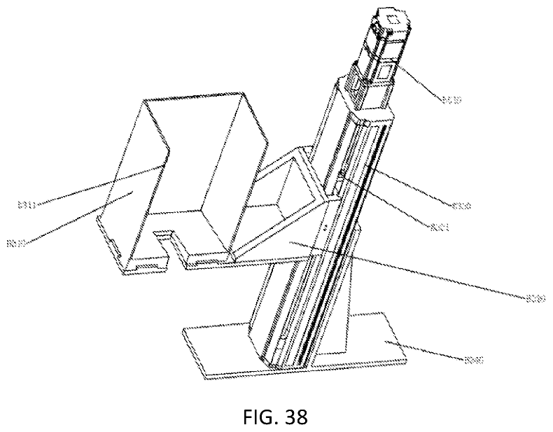

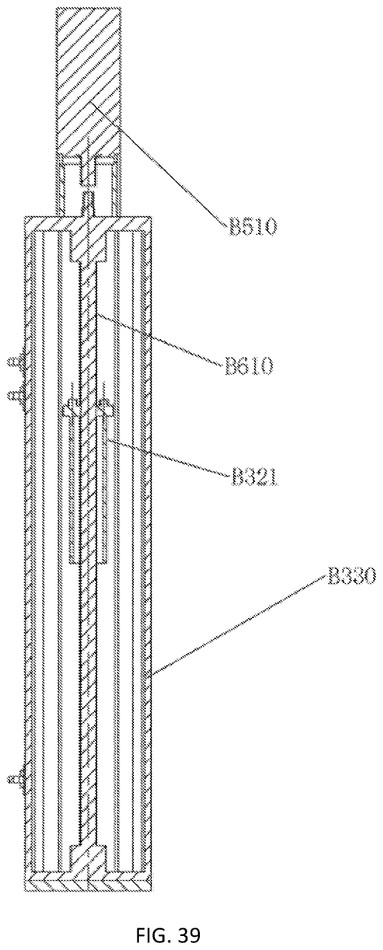

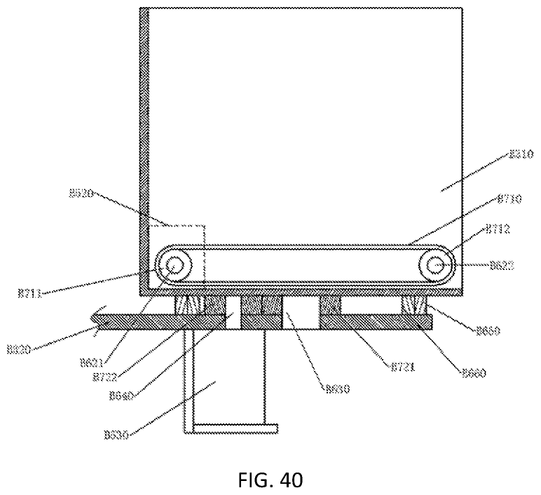

Referring to FIGS. 1-40, a multi-currency allocation assembly line comprises a machine core module A, a plastic packaging module B, a sorting assembly line C, and a manipulator E, wherein the machine core module A is configured for storing banknotes and outputting banknotes to the banknote receiving funnel D according to the system instruction.

The manipulator E is utilized for conveying banknotes in the banknote receiving funnel D into the plastic-package feeding mechanism B210 of the plastic packaging module B. The plastic packaging module B comprises a plastic packaging machine B200 and a stacking mechanism B300. The plastic packaging machine B200 is utilized for plastic film packaging of the stacked banknotes 100. The stacking mechanism is utilized for vertically stacking the stacked banknotes, and then output to the sorting and conveying mechanism C100 of the sorting assembly line C through the banknote outlet B111 arranged on the plastic packaging housing B110. The side face of the sorting and conveying mechanism C100 communicates with the sorting frame C300 through the inclined sorting plate C200. When in use, the sorting and conveying mechanism C100 conveys the stacked banknotes to the inclined sorting plate C200 corresponding to the preset sorting frame C300, and then pushes the banknotes to the top of the inclined sorting plate C200, so that the banknotes slide from the inclined sorting plate C200 to the sorting frame C300 due to gravity to complete the banknote allocation.

The machine core module A comprises a machine core housing A110 and a machine core framework A120. The machine core housing A110 is mounted outside the machine core framework A120. The machine core framework A120 comprises a machine core A200 mounted therein. Each of the machine cores A200 comprises a banknote receiving funnel D mounted at a banknote outlet thereof and a banknote receiving supporting plate A121 that the banknote receiving funnel D is affixed thereon. The banknote receiving supporting plate A121 is affixed on the machine core framework A120.

A sliding rail mounting plate E120 is further mounted at a bottom of the machine core framework A120. At least one sliding rail E110 is mounted on the sliding rail mounting plate E120, and the sliding rail E110 is engaged and slidably assembled with the supporting arm sliding block E213 on the manipulator E.

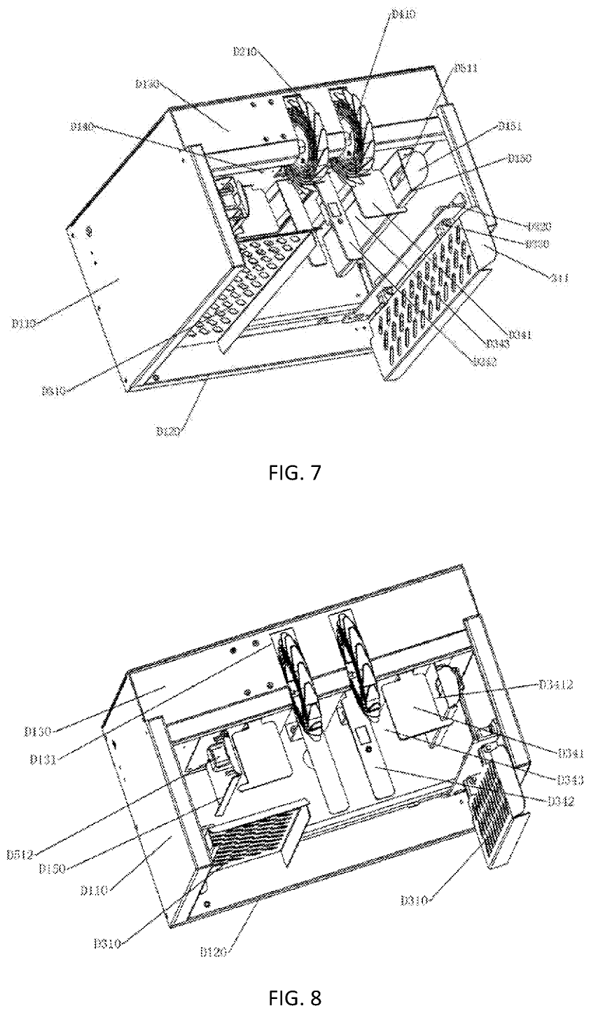

Referring to FIGS. 7-17, the banknote receiving funnel D comprises a banknote receiving side plate D110, a banknote receiving bottom plate D120, a banknote receiving top plate D130, a banknote receiving vertical plate D140, and a banknote receiving guide plate D150. The bottoms of the banknote receiving side plate D110, the banknote receiving top plate D130, the banknote receiving vertical plate D140, the banknote receiving guide plate D150 are respectively affixed on the banknote receiving bottom plate D120. There are two of the banknote receiving guide plates D150 and the banknote receiving guide plates D150 are respectively engaged and slidably assembled with the banknote receiving plate slots D3412 provided on the sides of a first banknote receiving plate D341. The banknote receiving guide plates D150 respectively have an inclined banknote receiving plate D151 arranged on the top thereof. The distance between the inclined banknote receiving plates D151 is gradually shorter from top to bottom. The minimum value of the distance is the spacing value between the banknote receiving guide plates D150.

The banknote receiving vertical plate D140 has at least two vertical plate through grooves D141 arranged therein, and the first banknote receiving plate D341 is provided with a first banknote receiving connecting plate D3411, wherein an end of the first banknote receiving connecting plate D3411 is assembled and affixed with the first banknote receiving plate D341, while the other end passes through the vertical plate through grooves D141 to be assembled and affixed with a banknote receiving connection plate D360. The banknote receiving connection plate D360 is further connected and affixed with a second banknote receiving connecting plate D342 through a second banknote receiving connecting plate D3421. The second banknote receiving connecting plate D3421 is engaged and slidably assembled with another vertical plate through grooves 141.

The first banknote receiving plate D341 and the second banknote receiving connecting plate D342 jointly form a banknote receiving plate. When in use, the banknote receiving plate is utilized for receiving the banknotes. The first banknote receiving plate D341 and the second banknote receiving connecting plate D342 form a banknote taking groove D343 therebetween. When in use, the first arm claw E251 and the second arm claw E252 of the manipulator E can pass through the banknote taking groove D343 to clamp and grasp the banknotes placed on the banknote receiving plate.

The banknote receiving connection plate D360 is assembled and affixed with a banknote receiving upper connection plate D611. The banknote receiving upper connection plate D611 is attached and assembled with an end of a banknote receiving supporting arc plate D610, while the other end of the banknote receiving supporting arc plate D610 is hinged with a banknote receiving lower connection plate D612 through a third banknote receiving shaft D430. The banknote receiving lower connecting plate D612 is mounted on a banknote receiving base plate D160, and the banknote receiving base plate D160 is affixed on the banknote receiving bottom plate D120. The third banknote receiving shaft D430 is sleeved with a banknote receiving torsion spring D620, and the banknote receiving torsion spring D620 is utilized for generating a torsion that prevents the banknote receiving supporting arc plate D610 from rotating towards the banknote receiving plate by taking the third banknote receiving shaft D430 as the center.

The banknote receiving top plate D130 comprises a banknote receiving wheel groove D131 arranged thereon and a banknote receiving wheel D210 mounted in the banknote receiving wheel groove D131. The banknote receiving wheel D210 is mounted on a first banknote receiving shaft D410, wherein the first banknote receiving shaft D410 is circumferentially rotatably assembled with the fringe of the banknote receiving top plate D130. The first banknote receiving shaft D410 also comprises a first encoder disk D220 mounted thereon, wherein the first encoder disk D220 has a plurality of first encoder slots penetratingly arranged on the circumference thereof. The edge of the first encoding disk D220 with the first encoder slots is inserted into a first encoder D533, wherein the first encoder D533 is a photoelectric sensor that generates a potential change when the first encoding slot passes, and outputs an electrical signal to determine a rotation speed and a rotation angle of the first encoding disk D220.

The first banknote receiving shaft D410 comprises a first gear D231 affixed at one end thereof, wherein the first gear D231 is engaged with a second gear D232, wherein the second gear D232 is affixed on an output shaft of a banknote receiving motor D520. When in use, the banknote receiving motor D520 is powered on, so as to drive the second gear D232 to rotate circumferentially, so as to drive the banknote receiving wheel D210 to rotate circumferentially.

The banknote receiving top plate D130 further comprises a banknote receiving corner plate D170 mounted on the bottom surface thereof. The banknote receiving corner plate D170 is assembled with one end of the second banknote receiving shaft D420. The other end of the second banknote receiving shaft D420 is assembled and affixed with the banknote receiving bottom plate D120. The second banknote receiving shaft D420 comprises a banknote receiving shaft sleeve D350 sleeved thereon. The banknote receiving shaft sleeve D350 is affixed on the banknote receiving connection plate D360 and is slidable relative to the second banknote receiving shaft D420 in an axial direction. Preferably, the second banknote receiving shaft D420 further comprises a banknote receiving pressure spring D630 sleeved on the portion thereof between the banknote receiving shaft sleeve D350 and the banknote receiving bottom plate D120. The banknote receiving pressure spring D630 is configured to provide a resilience to prevent the banknote receiving shaft sleeve D350 from moving towards the banknote receiving bottom plate, so as to provide buffering and limiting when the banknote receiving shaft sleeve D350 moves toward the banknote receiving bottom plate and approaches the banknote receiving bottom plate.

The banknote receiving side plate D110 comprises a fifth banknote receiving shaft D450 mounted thereon at a position close to the banknote receiving top plate. The fifth banknote receiving shaft D450 is circumferentially rotatably assembled with the banknote receiving side plate D110 and the fifth banknote receiving shaft D450 comprises a first banknote receiving belt pulley D241 mounted thereon. The first banknote receiving belt pulley D241 is connected with a second banknote receiving belt pulley D242 through a banknote receiving belt D240 to form a belt transmission mechanism. The second banknote receiving belt pulley D242 is mounted on a banknote receiving lifting output shaft of a banknote receiving lifting motor D550. The banknote receiving lifting motor D550 comprises a second encoder disk D250 mounted on the banknote receiving and lifting output shaft D440 thereof. The second encoder disk D250 has a plurality of second encoder slots penetrated thereon and evenly distributed on the circumference thereof. The second encoder disk D250 has a second encoder D534 allowing the edge of the second encoder slots inserted therein and when the second encoder slots pass through the second encoder, the second encoder outputs a signal, so as to determine the rotation speed and the rotation angle of the second encoder disk.

The banknote receiving belt D240 and the banknote receiving connection plate D360 are assembled and affixed with each other, so that the banknote receiving belt D240 can drive the banknote receiving connection plate D360 to move synchronously.

The fifth banknote receiving shaft D450 is also coaxially connected with the input shaft of a magnetic encoder D540, so that the rotating speed of the fifth banknote receiving shaft D450 can be detected through the magnetic encoder, wherein the magnetic encoder D540 is affixed on the bottom surface of the banknote receiving top plate.

Preferably, each of the two banknote receiving guide plates D150 further comprises a transmitter D511 and a receiver D512, wherein the transmitter D511 and the receiver D51 jointly form a photoelectric sensor. The transmitter transmits a light beam to the receiver, and the receiver receives the light beam and outputs an electrical signal. When in use, once the light beam between the transmitter D511 and the receiver D512 is shielded, the receiver will send a signal to an external industrial computer to determine if the banknote is too high. In this case, the banknote receiving lifting motor will be started, and the banknote receiving connection plate D360 will be driven to move downward synchronously by means of driving the banknote receiving belt to move, until the receiver D512 resumes receiving the light beam. According to the present embodiment, the banknote receiving lifting motor is a stepping motor, and each time the banknote receiving belt drives the banknote receiving connection plate D360 to move downward synchronously with a fixed height.

The banknote receiving connection plate D360 comprises a banknote receiving lifting sensing piece D361 on the side face thereof. The banknote receiving side plate D110 respectively comprises a first limiting sensor D531 and a second banknote receiving sensor D532 on the inner wall thereof in the vicinity of the up and down reciprocating path (axial direction of the second banknote receiving shaft) of the banknote receiving lifting sensing piece D361. The first limiting sensor D531 and the second banknote receiving sensor D532 are both photoelectric sensors, and when the banknote receiving lifting sensing piece D361 is installed in the first limiting sensor D531 or the second banknote receiving sensor D532, a potential change occurs, thereby outputting a signal to the industrial computer, to determine that the banknote receiving connection plate D360 reaches the maximum movement point, and at this time, the banknote receiving lifting motor stops and prepares to be reversed.

Preferably, the banknote receiving bottom plate D120 and the banknote receiving side plate D110 are respectively assembled and affixed with a banknote receiving door mounting plate D320. The banknote receiving door mounting plate D320 is hinged to one side of a banknote receiving door D310 through a door hinge D330, and a hinge torsion spring is mounted inside the door hinge D330. The hinge torsion spring is utilized for driving the banknote receiving door D310 to maintain the torque turning to the banknote receiving plate. This enables automatic closing of the banknote receiving door through the resilience of the hinge torsion spring after opened outwards.

When in use, the banknote receiving motor D520 is activated to drive the banknote receiving wheel to rotate circumferentially to receive the banknotes output from the corresponding machine core, and then place the banknotes on the first banknote receiving plate D341 and the second banknote receiving plate D342 until the light beam between the receiver D512 and the transmitter is blocked. Then the banknote receiving lifting motor drives the banknote receiving belt to drive the banknote receiving plate to move downward to a certain height, and then continue the banknote receiving until the first limiting sensor D531 inputs a signal to the industrial computer that determines the banknote receiving plate has reached the bottommost. At this time, the banknotes on the banknote receiving plate must be taken out.

In the downward moving process of the banknote receiving plate, the banknote receiving plate apply a torsional force to the top of the banknote receiving supporting arc plate D610 through the banknote receiving connection plate D360, so that the banknote receiving supporting arc plate D610 rotates, with the third banknote receiving shaft D430 as the center, towards the banknote receiving plate, so that the banknote receiving supporting arc plate D610 overcomes the resilience of the banknote receiving torsion spring D620 to rotate, so as to ensure the supporting to the banknote receiving connection plate D360 (the banknote receiving plate). After the banknotes on the banknote receiving plate are taken out, the banknote receiving lifting motor is reversed, and the banknote receiving plate is reset; that is, the second limiting sensor outputs a signal.

Preferably, in order to detect whether the banknotes have been taken out, the bottom surface of the second banknote receiving plate D342 further comprises a detection microswitch D560 arranged thereon. The trigger end of the detection microswitch faces the banknote taking groove D343, and when the first arm claw E251 and the second arm claw E252 are inserted into the banknote taking groove D343, the detection microswitch D560 will be triggered, so that the detection microswitch D560 sends a signal to the industrial computer to determine that the banknotes are taken out, so that the banknote receiving plate can be reset and reposition.

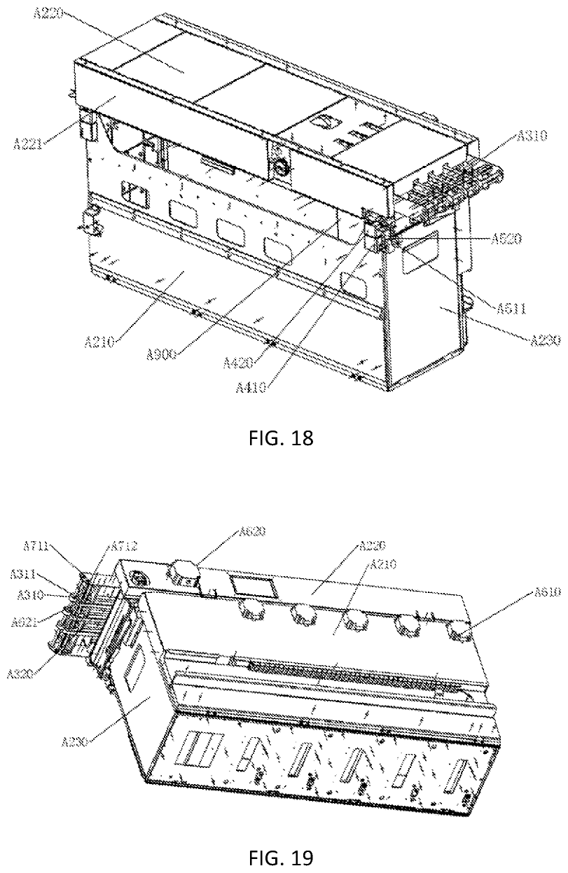

Referring to FIGS. 18-26, the machine core A200 comprises two machine core side plates A210, two machine core end plates A230, a machine core lid A220 mounted at the top of the two machine core side plates A210 and the two machine core end plates A230, wherein the two machine core side plates A210 and the two machine core end plates A230 are side by side connected respectively, so as to form four side walls of the machine core A200.

The machine core lid A220 has a machine core lid side plate A221 and a machine core lid end plate A222 arranged thereon, wherein a side of the machine core lid side plate A221 is hinge jointed with one of the machine core side plate A210 through a hinge, wherein the machine core lid end plate A222 has a machine core lock sliding groove A2221 penetratedly formed thereon, wherein the machine core lock sliding groove A2221 is slidably assembled with a fourth machine core lock rod A514, wherein the fourth machine core lock rod A514 penetrates through the two sides of the machine core lock sliding groove A2221 to be assembled and affixed with a machine core lock limiting ring A550 respectively, so as to relatively affixed the fourth machine core lock rod A514 at the machine core lock sliding groove axially.

The fourth machine core lock rod A514 is further assembled and affixed with an end of a first machine core lock plate A540, wherein the other end of the first machine core lock plate is A540 hinge jointed with the machine core end plate A230 through a third machine core lock rod A513, wherein the third machine core lock rod A513 is away from the side of the hinge joint of the third machine core lock rod and the machine core lid.

The core lid end plate is further hinged to an end of a second machine core lock plate through a second machine core lock shaft, wherein the other end of the second machine core lock plate has a machine core lock groove, wherein the machine core lock groove A521 is A511 coupled and assembled A512 with a A520 first machine core lock rod, wherein the first machine core lock rod is affixed on the machine core end plate.

The second machine core lock plate A520 is further assembled and affixed with an end of a machine core extension spring A530, wherein the other end of the machine core extension spring A530 is assembled and affixed with a fifth machine core lock rod A515, wherein the fifth machine core lock rod A515 is affixed on the core lid end plate A222. The machine core extension spring A530 and the machine core lock groove A521 are respectively disposed at the two ends of the second machine core lock plate A520 located on the second machine core lock bar A512, so that the resilience generated by the machine core extension spring A530 can ensure that the second machine core lock plate A520 rotates toward the machine core lock groove A521 with the second machine core lock rod A512 as the center so as to keep the machine core lock groove A521 in a coupled state with the first machine core lock rod.

The machine core lock sliding groove A2221 has a plurality of limiting slots A2222 arranged thereon. When in use, the machine core lock groove A521 is firstly rotated to disengage from the first machine core lock rod A511, and then the machine core lid A220 is opened through turning with the hinge as the center. Until it has reached the required opening angle, the fourth machine core lock rod A514 is buckled into the approached limiting slots A2222 to support the machine core lid A220, so that the opening angle of the machine core lid can be maintained to facilitate the maintenance.

Preferably, the third machine core lock rod A513 comprises a machine core torsion spring A560 sleeved thereon, wherein the machine core torsion spring A560 provides a resilience to hinder the first machine core lock plate A540 from rotating in a direction away from the first machine core lock plate. Therefore, the fourth machine core lock rod A514 is kept in the machine core lock sliding groove A2221 at the end closest to the second machine core lock plate or is stuck in the limiting slots A2222.

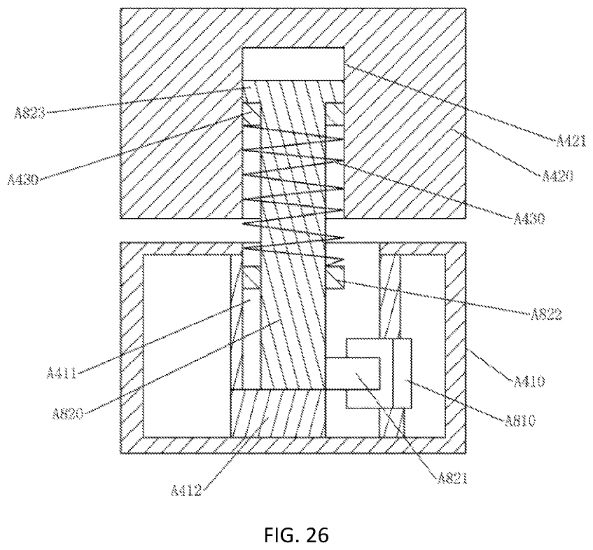

Referring to FIG. 26, each of the machine core lid A220 and the machine core side plates A210 comprises an upper closing detection shell A420 and a lower closing detection shell A410 arranged thereon, wherein the upper closing detection shell A420 has an upper closing sliding groove A421 and an upper closing sliding block A823 slidably mounted in the upper closing sliding groove A421, wherein the upper closing sliding block A823 is affixed at one end of a closing sliding rod A820, wherein the other end of the closing sliding rod A820 penetrates through an upper closing limiting ring A822 to be assembled and affixed with a closing detection piece A821, wherein the upper closing limiting ring A822 is affixed in the upper closing sliding groove A421.

A lower closing limiting ring A822 is mounted between the closing sliding rod A820 located between the upper closing limiting ring A822 and the closing detection piece A821, wherein the closing sliding rod A820 comprises a closing pressure spring A430 sleeved on the portion thereof between the upper closing limiting ring A822 and the lower closing limiting ring A822.

The lower closing detection shell A410 comprises a closing detection groove A411 provided therein and a closing detection sensor A810 mounted on the inner wall of the closing detection groove, wherein the closing detection sensor A810 is a photoelectric sensor, which signal is the same as the first limiting sensor or the second limiting sensor. When the closing detection piece A821 is loaded into the detection sensor A810, the detection sensor A810 outputs a signal since a potential change occurs, thereby determining that the machine core lid A 220 has been closed.

The closing detection groove A411 comprises a closing limiting table A412 affixed at the bottom thereof. The closing limiting table A412 is tightly attached to the bottom surface of the closing sliding rod A820, so as to limit the closing sliding rod A820.

When the machine core lid is turned toward the machine core side plate to close, the closing sliding rod A820 is installed in the closing detection groove A411 until the closing detection piece A821 is loaded into the detection sensor A810. At this time, the detection sensor A810 inputs a signal to the industrial computer to determine that the closing has been in place. In this process, the closing pressure spring A430 functions as a damping buffer.

The machine core A200 has a hollow machine core mounting cavity A201 provided internally and comprises a plurality of banknote boxes A900 mounted in the machine core mounting cavity A201, wherein the banknote outputting mechanism of each of the banknote boxes A900 is respectively driven by a first machine core motor A610, thereby allowing each of the banknote boxes A900 to output the banknotes stored therein independently. The banknote box of the present embodiment is embodied as a conventional bank cash box directly purchased from the market.

A first machine core belt A310, a second machine core belt A320, and a third machine core belt A330 are respectively provided and mounted under the machine core lid and above the banknote boxes A900, wherein the second machine core belt A320 is located at the banknote outlet of the machine core above the banknote receiving wheel D210, so as to coordinate with the first machine core belt A310 to clamp and convey the banknotes (the banknotes are clamped between the second machine core belt A320 and the first machine core belt A310). The first machine core belt A310, the second machine core belt A320, and the third machine core belt A330 are respectively wound around a plurality of first machine core belt pulleys A311, second machine core belt pulleys A321, and third machine core belt pulleys A331 to form a belt transmission mechanism, wherein the first machine core belt pulleys A331, the second machine core belt pulleys A321, and the third machine core belt pulleys A331 are respectively mounted on a first machine core shaft A711, a second machine core shaft A712 or a third machine core shaft A720 correspondingly thereto, wherein the first machine core shaft A711, the second machine core shaft A712, and the third machine core shaft A720 are respectively rotatably assembled with the machine core lid side plate A221 in a circumferential rotation manner.

Here, one of the first machine core shaft A711, the second machine core shaft A712, and the third machine core shaft A720 penetrates through one of the machine core lid side plate A221 to be connected with three different output shafts of the second machine core electrical motors A620 through the coupler, so that the powered-on second machine core electrical motors A620 drives the first machine core shaft A711, the second machine core shaft A712, and the third machine core shaft A720 to rotate circumferentially respectively. Namely, the first machine core belt A310, the second machine core belt A320, and the third machine core belt A330 all rotate circumferentially.

A fourth machine core belt A340 and a fifth machine core belt A350 are arranged below the portion of the first machine core belt A310 and the third machine core belt A330 located inside of the machine core mounting cavity A201 to coordinate thereto for clamping and conveying banknotes, wherein the fourth machine core belt A340 and the fifth machine core belt A350 respectively surround around a fourth machine core belt pulley A341 and a fifth machine core belt pulley A351 to form a belt transmission mechanism, wherein the fourth machine core belt pulley A341 and the fifth machine core belt pulley A351 are respectively mounted on a fourth machine core shaft A731 and a fifth machine core shaft A732, wherein the two ends of the fourth machine core shaft A731 and the fifth machine core shaft A732 are respectively circumferentially rotatably assembled on the machine core lid side plate A221.

When in use, the banknote box A900 outputs the banknotes therein to the place between the fifth machine core belt A350 and the third machine core belt A340 or the place between the first machine core belt A310 and the fourth machine core belt A340 under the driving of the first machine core motor corresponding thereto. Then the second machine core electrical motors is started, so that the third machine core belt A330 and the first machine core belt A310 convey the banknotes to the place between the first machine core belt A310 and the second machine core belt A320. Finally, the banknotes are separated from the first machine core belt A310 and the second machine core belt A320, received by the banknote receiving wheel, and placed on the banknote receiving plate.

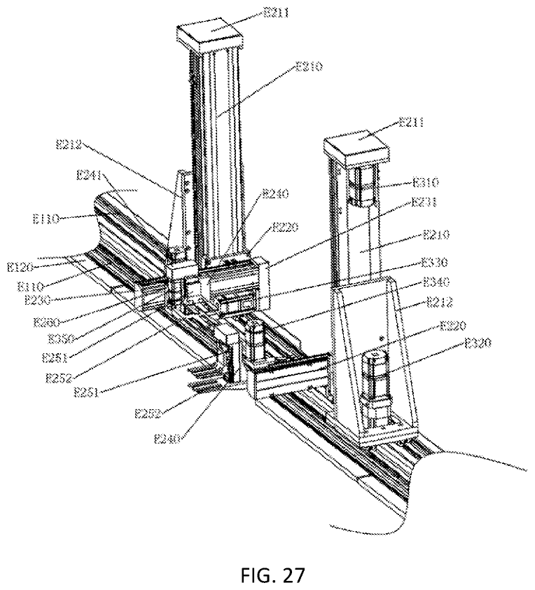

Referring to FIGS. 27-34, the manipulator E comprises a first support arm E210, a second support arm E230, and a third support arm E240. The first support arm E210 comprises a first support arm cover E211 mounted at the top thereof and a supporting arm bottom plate E214 mounted at the bottom thereof. The supporting arm bottom plate E214 comprises a supporting arm sliding block E213 affixed at the bottom thereof and a supporting arm reinforcing plate E212 affixed between the top surface of the supporting arm bottom plate E214 and the side face of the first support arm E210.

A traveling motor E320 is affixed on the supporting arm bottom plate E214. A traveling output shaft E321 of the traveling motor E320 penetrates out of the supporting arm bottom plate E214 to be assembled and affixed with a traveling gear E420. The supporting arm sliding block E213 is engaged and slidably assembled with the sliding rail E110. The traveling gear E420 is meshed with a traveling rack (not shown in the figures) affixed on the sliding rail mounting plate so as to form a gear rack transmission mechanism. When in use, the powered-on traveling motor E320 drives the traveling gear E420 to rotate forward or reverse, so that the entire manipulator E slides along the sliding rail E110 under the meshing effect of the traveling gear E420 and the traveling rack.

The first support arm E210 comprises a circumferentially rotatable first support arm screw rod E510 mounted therein. An end of the first supporting arm screw rod E510 is rotatably assembled with the supporting arm bottom plate E214, while the other end of the first supporting arm screw rod penetrates out of the first supporting arm to enter the first supporting arm cover E211 to be assembled and affixed with a first second supporting arm belt pulley E412. The first second supporting arm belt pulley E412 is connected with a first first supporting arm belt pulley E410 through a first supporting arm belt so as to form a belt transmission mechanism. The first first supporting arm belt pulley E411 is mounted on an output shaft of a supporting arm lifting motor E310, wherein the supporting arm lifting motor E310 is affixed on the first supporting arm E210. When in use, the supporting arm lifting motor E310 is powered on, so as to drive the first second supporting arm belt pulley E412 circumferentially rotate, which is to drive the first support arm screw rod circumferentially rotate.

The first support arm screw rod E510 and a supporting arm lifting sliding plate E220 are assembled through threads. The supporting arm lifting sliding plate E220 is engaged and vertical slidably assembled with the first supporting arm A210. Circular rotation of the first support arm screw rod E510 can drive the supporting arm lifting sliding plate E220 to move axially.

The second support arm E230 is affixed on the supporting arm lifting sliding plate E220. The second support arm E230 comprises a second support arm cover E231 mounted on an end thereof and a second support arm screw rod E520 mounted inside of the second support arm E230. An end of the second support arm screw rod E520 is rotatably assembled in the second support arm E230 with the end thereof away from the second support arm cover E231, while the other end of the second support arm screw rod E520 penetrates out of the second support arm cover E231 to enter the second support arm cover E231 to be assembled and affixed with a second first support arm belt pulley E431. The second first belt pulley E431 is connected with the second first support arm belt pulley E432 through a second support arm belt E430 to form a belt transmission mechanism. The second first supporting arm belt pulley E432 is mounted on an output shaft of a supporting arm lateral movement motor E330. The supporting arm lateral movement motor E330 is affixed on the second supporting arm E230.

The second support arm screw rod E520 and a supporting arm lateral movement sliding plate E260 are assembled through threads. The supporting arm lateral movement sliding plate E260 is coupled and slidably assembled with the outer wall of the second supporting arm E230. The supporting arm lateral movement sliding plate E260 comprises a supporting arm hinge frame E270 affixed thereon. When in use, the powered-on supporting arm lateral movement motor E330 drives the second support arm screw rod E520 to rotate circumferentially, so as to drive the supporting arm lateral movement sliding plate E260 to move in the axial direction.

The supporting arm hinge frame E270 comprises a supporting arm rotating motor E340 installed thereon. An output shaft of the supporting arm rotating motor E340 is assembled and affixed with an end of the second arm claw E252 and the third supporting arm E240 through a coupler and a supporting arm hinge shaft E540. When in use, the supporting arm rotating motor E340 is powered on to drive an end of the second arm claw E252, and the third supporting arm E240 rotates by a certain angle with its output shaft as the center. That is, the rotation angle of the first arm claw E251 and the second arm claw E252 is adjusted. The supporting arm rotating motor E340 may be a servo motor or a stepping motor.

The third support arm E240 comprises a third supporting arm screw rod E530 mounted inside thereof. An end of the third supporting arm screw rod E530 is rotatably assembled with the second arm claw E252, while the other end of the third supporting arm screw rod E530 passes through a third supporting arm E240 to enter a third supporting arm cover E241 to be assembled and affixed with a third second supporting arm belt pulley E442. The third supporting arm cover E241 is mounted on the third supporting arm E240 and the third second supporting arm belt pulley E442 is connected with a third first supporting arm belt pulley E441 through a third supporting arm belt E440 so as to form a belt transmission mechanism. The third first supporting arm belt pulley E441 is affixed on the output shaft of a clamping motor E350. The clamping motor E350 is affixed on the third supporting arm E240. The third supporting arm screw rod E530 and an end of the first arm claw E251 are screwed and assembled. The end of the first arm claw E251 is buckled in an adjustment sliding groove E242 of the third support arm E240. When in use, the clamping motor E350 is powered on to drive the third supporting arm screw rod E53 to rotate circumferentially, and the third supporting arm screw rod E53 drives the first arm claw E251 to move in the axial direction through the thread, so that the distance between the first arm claw E251 and the second arm claw E252 can be adjusted.

To grab the banknotes in the banknote receiving funnel, the manipulator moves to a position corresponding to the banknote receiving funnel, and then the supporting arm rotating motor is started to drive the first arm claw E251 and the second arm claw E252 to rotate to a position parallel to the banknote taking groove D343, so that the first arm claw E251 and the second arm claw E252 are parallel to the second supporting arm E230. Next, the clamping motor E 350 is started, so that the distance between the first arm claw E251 and the second arm claw E252 reaches the maximum. Then the supporting arm lifting motor E310 is started, such that the portion of the banknote receiving plate to the transmitter is located in the portion between the first arm claw E251 and the second arm claw E252. Then the supporting arm lateral movement motor E330 is started, so that the first arm claw E251 and the second arm claw E252 respectively reach the position above of the top of the banknotes and below the banknote receiving plate. Then, the clamping motor rotates reversely, so that the first arm claw E251 approaches to the second arm claw E252 to clamp the banknotes. Next, the supporting arm lateral movement motor E330 reversely drives the first arm claw E251 and the second arm claw E252 to reset and reposition, and the s supporting arm rotating motor reversely drives the first arm claw E251 and the second arm claw E252 to reversely reset. The traveling motor E320 reversely drive the manipulator to move along the sliding rail to the end of the plastic-package feeding mechanism. At this time, the first arm claw E251 and the second arm claw E252 are located above the plastic-package feeding mechanism B210. Then the supporting arm lifting motor reversely rotates to drive the second arm claw E252 to be in contact with the top surface of the plastic-package feeding mechanism B 10. Then, the clamping motor rotate forward to drive the first arm claw E251 move in the direction away from the second arm claw E252 to release the banknotes. Then the first arm claw E251 and the second arm claw E252 are reposition and reset to finish the entire process. By means of the manipulator E, the transfer between the banknotes in the banknote receiving funnel and the plastic-package feeding mechanism B210 can be achieved, and the whole process can be automation, so that the efficiency is extremely high, and the error rate is extremely low.

Referring to FIGS. 35-40, preferably, the plastic packaging machine B200 may be a conventional thin film double-film packaging machine. According to this embodiment, the BOGA20170804450 model plastic packaging machine provided by Boga is directly purchased. The banknotes are plastic packaged through the plastic-package feeding mechanism, and then output to the stacking mechanism B300 through a plastic packaging discharging mechanism B220. According to the present embodiment, the feeding mechanism and the discharging mechanism are both conveying belts.

The stacking mechanism B300 comprises a stacking bracket B330 and a stacking box B310, wherein the stacking box B310 is mounted on the stacking connection plate B320 and comprises a hinging cylinder B321 affixed on an end thereof. The hinging cylinder B321 and a stacking screw rod B610 are assembled through threads. An end of the stacking screw rod B610 is circumferentially rotatably assembled with the stacking bracket B330, while the other end of the stacking screw rod B610 penetrates out of the stacking bracket B330 to be connected and assembled with an output shaft of a stacking lifting motor B510 through a coupler. The stacking lifting motor B510 is mounted at the top of the stacking bracket B330.

The stacking box B310 comprises a first stacking shaft B630 affixed on the bottom thereof, and a first sleeving ring B650, wherein the first stacking shaft B630 and the stacking connection plate B320 are rotatably assembled in a circumferential manner. The first sleeving ring B650 is sleeved outside a second sleeving ring B660 and is circumferentially rotatably assembled therewith. The second sleeving ring B660 is affixed on the stacking connection plate B320.

The first stacking shaft B630 comprises a first stacking gear B721 mounted thereon. The first stacking gear B721 is engaged with a second stacking gear B722 in a drivable manner. The second stacking gear B722 is mounted on a second stacking shaft B640, and the second stacking shaft B640 is connected with the output shaft of a rotating motor B530 through a coupler. The powered-on rotating motor B530 can start the rotation of the second stacking gear B722 in a circumferential direction. The rotating motor B530 is affixed on the stacking connection plate B320. The start of the rotation motor B530 can drive the first stacking gear B721 to rotate, so as to drive the stacking box B310 to rotate synchronously.

The stacking box B310 comprises an output belt B710 mounted at the bottom thereof, wherein the output belt B710 is sleeved on a first output belt pulley B711 and a second output belt pulley B712 to form a belt transmission mechanism. The first output belt pulley B621 and the second output belt pulley B622 are respectively mounted on a first output shaft B621 and a second output shaft B622, wherein the first output shaft B621, the second output shaft B622, and the side wall of the stacking box B310 are circumferentially rotatably assembled, wherein an end of the first output shaft B621 penetrates out of the stacking box B310 to be connected with the output shaft of an output motor B520 through a coupler. When in use, the output motor B520 may be started, thereby driving the output belt B710 to rotate to output the stacked banknotes placed on the output belt B710 from the stacking box B310.

When in use, a box opening B311 of the stacking box B310 faces the plastic packaging discharging mechanism B220, so that the stacked banknotes enter the stacking box B310 to be stacked, and the stacking box B310 can be driven by the stacking lifting motor B510 to gradually move down in order to achieve this process. After a batch of banknotes is taken out, stacked, and put into the stacking box B310 to be piled, the stacking lifting motor B510 rotates reversely to drive the stacking box B310 to ascend to a position flush with the banknote outlet. Next, the rotating motor B530 is started to drive the stacking box B310 to rotate by 180 degrees, so that the box opening B311 directly faces the banknote outlet B111. Finally, the output motor B520 is started, so that the output belt B710 outputs the stacked banknotes out of the banknote outlet B111.

Preferably, the plastic packaging discharging mechanism B220 comprises a labeling machine B400 mounted thereon. The labeling machine B400 is utilized to print the label and attach the label onto the stacked banknotes.

The banknote box of the present embodiment may refer to the banknote box disclosed in the China patent with the publication number CN206849156U. In addition, the structure and manner of outputting the banknotes to the above of the banknote receiving wheel by the banknote box in the machine core may refer to the China patent with the publication number CN107067541A. At this time, whether the first machine core belt A310, the second machine core belt A320, the third machine core belt A330, the fourth machine core belt A340, and the fifth machine core belt A350 have to be provided and arranged should depend on the circumstances.

Those the present invention has not described in detail refers to ordinary technologies for person skilled in the art.

The above detailed description describes preferred embodiments of the present invention. It should be understood that many modifications and variations can be made by one of ordinary skill in the art without creative efforts in accordance with the concepts of the present invention. Therefore, all technical solutions that can be obtained through logic analysis, reasoning or limited experiment, on the basis of the technology with the concept of the present invention through person skilled in the art shall be within the protected scope of the present invention as defined by the appended claims.

1: A machine core, comprising:
two machine core side plates, two machine core end plates, and a machine core lid mounted at a top portion of said two machine core side plates and said two machine core end plates, wherein said two machine core side plates and said two machine core end plates are connected side by side to form four side walls of the machine core;
wherein said machine core lid has a machine core lid side plate and a machine core lid end plate arranged thereon, wherein a side of said machine core lid side plate is hingedly jointed with one of said machine core side plate through a hinge, wherein said machine core lid end plate has a machine core lock sliding groove penetratedly formed therein, wherein a fourth machine core lock rod, which is slidably assembled in said machine core lock sliding groove, penetrates through two sides of said machine core lock sliding groove to be assembled and affixed with a machine core lock limiting ring respectively;
wherein said fourth machine core lock rod is further assembled and affixed with an end of a first machine core lock plate, wherein another end of said first machine core lock plate is hingedly jointed with said machine core end plate through a third machine core lock rod, wherein said third machine core lock rod is positioned away from a side of a hinge joint of said third machine core lock rod and said machine core lid;
wherein said core lid end plate is further hinged to an end of a second machine core lock plate through a second machine core lock shaft, wherein another end of said second machine core lock plate has a machine core lock groove, wherein a first machine core lock rod is coupled and assembled in said machine core lock groove, wherein said first machine core lock rod is affixed on said machine core end plate;
wherein said second machine core lock plate is further assembled and affixed with an end of a machine core extension spring, wherein another end of said machine core extension spring is assembled and affixed with a fifth machine core lock rod, wherein said fifth machine core lock rod is affixed on said core lid end plate.

2: The machine core, as recited in claim 1, wherein said machine core extension spring and said machine core lock groove are respectively disposed at two ends of said second machine core lock plate located at a second machine core lock rod.

3: The machine core, as recited in claim 1, wherein said machine core lock sliding groove has a plurality of limiting slots formed therein, allowing said fourth machine core lock rod to be coupled in said limiting slots.

4: The machine core, as recited in claim 1, wherein said third machine core lock rod comprises a machine core torsion spring sleeved thereon, wherein said machine core torsion spring provides a resilience to hinder said first machine core lock plate from rotating in a direction away from said first machine core lock plate.

5: The machine core, as recited in claim 1, wherein each of said machine core lid and said machine core side plates comprises an upper closing detection shell and a lower closing detection shell arranged thereon, wherein said upper closing detection shell has an upper closing sliding groove and an upper closing sliding block slidably mounted in said upper closing sliding groove, wherein said upper closing sliding block is affixed at one end of a closing sliding rod, wherein another end of said closing sliding rod penetrates through an upper closing limiting ring to be assembled and affixed with a closing detection piece, wherein said upper closing limiting ring is affixed in said upper closing sliding groove;
wherein a lower closing limiting ring is mounted between said closing sliding rod located between said upper closing limiting ring and said closing detection piece, wherein said closing sliding rod comprises a closing pressure spring sleeved on the portion thereof between said upper closing limiting ring and said lower closing limiting ring;
wherein said lower closing detection shell comprises a closing detection groove provided therein and a closing detection sensor is mounted on an inner wall of said closing detection groove, wherein said closing detection sensor is a photoelectric sensor, which signal is the same as at least one of said first limiting sensor and said second limiting sensor, wherein a closing limiting table is affixed at a bottom of said closing detection groove, wherein said closing limiting table is attached to a bottom surface of said closing sliding rod, so as to limit said closing sliding rod.

6: The machine core, as recited in claim 1, wherein said machine core, which has a hollow machine core mounting cavity provided internally, comprises a plurality of banknote boxes mounted in said machine core mounting cavity, wherein the banknote outputting mechanism of each of said banknote boxes is driven by a first machine core motor;
wherein a first machine core belt, a second machine core belt, and a third machine core belt are respectively provided and mounted under said machine core lid and above said banknote boxes, wherein said second machine core belt is located at the banknote outlet of said machine core above the banknote receiving wheel, so as to coordinate with said first machine core belt to clamp and convey the banknotes, wherein said first machine core belt, said second machine core belt, and said third machine core belt are respectively wound around a plurality of first machine core belt pulleys, second machine core belt pulleys, and third machine core belt pulleys to form a belt transmission mechanism, wherein said first machine core belt pulleys, said second machine core belt pulleys, and said third machine core belt pulleys are mounted on a first machine core shaft, a second machine core shaft and a third machine core shaft respectively thereto, wherein said first machine core shaft, said second machine core shaft, and said third machine core shaft are respectively rotatably assembled with said machine core lid side plate in a circumferential rotation manner;
wherein one of said first machine core shaft, said second machine core shaft, and said third machine core shaft penetrates through one of said machine core lid side plate to be connected with output shafts of three second machine core electrical motors respectively through a coupler.

7: The machine core, as recited in claim 6, wherein a fourth machine core belt and a fifth machine core belt are arranged below the portion of said first machine core belt and said third machine core belt located inside of said machine core mounting cavity to coordinate thereto for clamping and conveying banknotes, wherein said fourth machine core belt and said fifth machine core belt respectively surround around a fourth machine core belt pulley and a fifth machine core belt pulley to form a belt transmission mechanism, wherein said fourth machine core belt pulley and said fifth machine core belt pulley are respectively mounted on a fourth machine core shaft and a fifth machine core shaft, wherein the two ends of said fourth machine core shaft and said fifth machine core shaft are respectively circumferentially rotatably assembled on said machine core lid side plate.

8-10. (canceled)

11: The machine core, as recited in claim 2, wherein said machine core, which has a hollow machine core mounting cavity provided internally, comprises a plurality of banknote boxes mounted in said machine core mounting cavity, wherein the banknote outputting mechanism of each of said banknote boxes is driven by a first machine core motor;
wherein a first machine core belt, a second machine core belt, and a third machine core belt are respectively provided and mounted under said machine core lid and above said banknote boxes, wherein said second machine core belt is located at the banknote outlet of said machine core above the banknote receiving wheel, so as to coordinate with said first machine core belt to clamp and convey the banknotes, wherein said first machine core belt, said second machine core belt, and said third machine core belt are respectively wound around a plurality of first machine core belt pulleys, second machine core belt pulleys, and third machine core belt pulleys to form a belt transmission mechanism, wherein said first machine core belt pulleys, said second machine core belt pulleys, and said third machine core belt pulleys are mounted on a first machine core shaft, a second machine core shaft and a third machine core shaft respectively thereto, wherein said first machine core shaft, said second machine core shaft, and said third machine core shaft are respectively rotatably assembled with said machine core lid side plate in a circumferential rotation manner;
wherein one of said first machine core shaft, said second machine core shaft, and said third machine core shaft penetrates through one of said machine core lid side plate to be connected with output shafts of three second machine core electrical motors respectively through a coupler.

12: The machine core, as recited in claim 11, wherein a fourth machine core belt and a fifth machine core belt are arranged below the portion of said first machine core belt and said third machine core belt located inside of said machine core mounting cavity to coordinate thereto for clamping and conveying banknotes, wherein said fourth machine core belt and said fifth machine core belt respectively surround around a fourth machine core belt pulley and a fifth machine core belt pulley to form a belt transmission mechanism, wherein said fourth machine core belt pulley and said fifth machine core belt pulley are respectively mounted on a fourth machine core shaft and a fifth machine core shaft, wherein the two ends of said fourth machine core shaft and said fifth machine core shaft are respectively circumferentially rotatably assembled on said machine core lid side plate.

13: The machine core, as recited in claim 3, wherein said machine core, which has a hollow machine core mounting cavity provided internally, comprises a plurality of banknote boxes mounted in said machine core mounting cavity, wherein the banknote outputting mechanism of each of said banknote boxes is driven by a first machine core motor;
wherein a first machine core belt, a second machine core belt, and a third machine core belt are respectively provided and mounted under said machine core lid and above said banknote boxes, wherein said second machine core belt is located at the banknote outlet of said machine core above the banknote receiving wheel, so as to coordinate with said first machine core belt to clamp and convey the banknotes, wherein said first machine core belt, said second machine core belt, and said third machine core belt are respectively wound around a plurality of first machine core belt pulleys, second machine core belt pulleys, and third machine core belt pulleys to form a belt transmission mechanism, wherein said first machine core belt pulleys, said second machine core belt pulleys, and said third machine core belt pulleys are mounted on a first machine core shaft, a second machine core shaft and a third machine core shaft respectively thereto, wherein said first machine core shaft, said second machine core shaft, and said third machine core shaft are respectively rotatably assembled with said machine core lid side plate in a circumferential rotation manner;
wherein one of said first machine core shaft, said second machine core shaft, and said third machine core shaft penetrates through one of said machine core lid side plate to be connected with output shafts of three second machine core electrical motors respectively through a coupler.

14: The machine core, as recited in claim 13, wherein a fourth machine core belt and a fifth machine core belt are arranged below the portion of said first machine core belt and said third machine core belt located inside of said machine core mounting cavity to coordinate thereto for clamping and conveying banknotes, wherein said fourth machine core belt and said fifth machine core belt respectively surround around a fourth machine core belt pulley and a fifth machine core belt pulley to form a belt transmission mechanism, wherein said fourth machine core belt pulley and said fifth machine core belt pulley are respectively mounted on a fourth machine core shaft and a fifth machine core shaft, wherein the two ends of said fourth machine core shaft and said fifth machine core shaft are respectively circumferentially rotatably assembled on said machine core lid side plate.

15: The machine core, as recited in claim 4, wherein said machine core, which has a hollow machine core mounting cavity provided internally, comprises a plurality of banknote boxes mounted in said machine core mounting cavity, wherein the banknote outputting mechanism of each of said banknote boxes is driven by a first machine core motor;
wherein a first machine core belt, a second machine core belt, and a third machine core belt are respectively provided and mounted under said machine core lid and above said banknote boxes, wherein said second machine core belt is located at the banknote outlet of said machine core above the banknote receiving wheel, so as to coordinate with said first machine core belt to clamp and convey the banknotes, wherein said first machine core belt, said second machine core belt, and said third machine core belt are respectively wound around a plurality of first machine core belt pulleys, second machine core belt pulleys, and third machine core belt pulleys to form a belt transmission mechanism, wherein said first machine core belt pulleys, said second machine core belt pulleys, and said third machine core belt pulleys are mounted on a first machine core shaft, a second machine core shaft and a third machine core shaft respectively thereto, wherein said first machine core shaft, said second machine core shaft, and said third machine core shaft are respectively rotatably assembled with said machine core lid side plate in a circumferential rotation manner;
wherein one of said first machine core shaft, said second machine core shaft, and said third machine core shaft penetrates through one of said machine core lid side plate to be connected with output shafts of three second machine core electrical motors respectively through a coupler.

16: The machine core, as recited in claim 15, wherein a fourth machine core belt and a fifth machine core belt are arranged below the portion of said first machine core belt and said third machine core belt located inside of said machine core mounting cavity to coordinate thereto for clamping and conveying banknotes, wherein said fourth machine core belt and said fifth machine core belt respectively surround around a fourth machine core belt pulley and a fifth machine core belt pulley to form a belt transmission mechanism, wherein said fourth machine core belt pulley and said fifth machine core belt pulley are respectively mounted on a fourth machine core shaft and a fifth machine core shaft, wherein the two ends of said fourth machine core shaft and said fifth machine core shaft are respectively circumferentially rotatably assembled on said machine core lid side plate.

17: The machine core, as recited in claim 5, wherein said machine core, which has a hollow machine core mounting cavity provided internally, comprises a plurality of banknote boxes mounted in said machine core mounting cavity, wherein the banknote outputting mechanism of each of said banknote boxes is driven by a first machine core motor;
wherein a first machine core belt, a second machine core belt, and a third machine core belt are respectively provided and mounted under said machine core lid and above said banknote boxes, wherein said second machine core belt is located at the banknote outlet of said machine core above the banknote receiving wheel, so as to coordinate with said first machine core belt to clamp and convey the banknotes, wherein said first machine core belt, said second machine core belt, and said third machine core belt are respectively wound around a plurality of first machine core belt pulleys, second machine core belt pulleys, and third machine core belt pulleys to form a belt transmission mechanism, wherein said first machine core belt pulleys, said second machine core belt pulleys, and said third machine core belt pulleys are mounted on a first machine core shaft, a second machine core shaft and a third machine core shaft respectively thereto, wherein said first machine core shaft, said second machine core shaft, and said third machine core shaft are respectively rotatably assembled with said machine core lid side plate in a circumferential rotation manner;
wherein one of said first machine core shaft, said second machine core shaft, and said third machine core shaft penetrates through one of said machine core lid side plate to be connected with output shafts of three second machine core electrical motors respectively through a coupler.

18: The machine core, as recited in claim 17, wherein a fourth machine core belt and a fifth machine core belt are arranged below the portion of said first machine core belt and said third machine core belt located inside of said machine core mounting cavity to coordinate thereto for clamping and conveying banknotes, wherein said fourth machine core belt and said fifth machine core belt respectively surround around a fourth machine core belt pulley and a fifth machine core belt pulley to form a belt transmission mechanism, wherein said fourth machine core belt pulley and said fifth machine core belt pulley are respectively mounted on a fourth machine core shaft and a fifth machine core shaft, wherein the two ends of said fourth machine core shaft and said fifth machine core shaft are respectively circumferentially rotatably assembled on said machine core lid side plate.

19: A multi-currency allocation assembly line, comprising a machine core module, a plastic packaging module, a sorting assembly line, and a manipulator;
wherein said machine core module is configured for storing banknotes and outputting banknotes to said banknote receiving funnel according to a system instruction;
wherein said manipulator is configured for conveying the banknotes in said banknote receiving funnel to the plastic-package feeding mechanism of said plastic packaging module, wherein said plastic packaging machine plastic packages and outputs the stacked banknotes to a stacking mechanism, wherein said stacking mechanism stacks and outputs the same type of banknotes to a sorting and conveying mechanism of said sorting assembly line from a banknote outlet, wherein a side surface of said sorting and conveying mechanism communicates with a sorting frame through an inclined sorting plate, wherein said machine core module comprises a machine core housing and a machine core framework, wherein said machine core housing is mounted outside said machine core framework, wherein each of said machine cores is installed in said machine core framework, wherein said machine core respectively has a banknote receiving funnel installed at each of the banknote outlets, wherein said banknote receiving funnel is affixed on a banknote receiving supporting plate, wherein said banknote receiving supporting plate is affixed on said machine core framework, wherein said machine core framework further comprises a sliding rail mounting plate mounted on a bottom thereof, wherein said sliding rail mounting plate comprises at least one sliding rail mounted thereon, wherein said at least one sliding rail is engaged and slidably assembled with a supporting arm sliding block on said manipulator.

20: The multi-currency allocation assembly line, as recited in claim 19, wherein said machine core module comprises:
two machine core side plates, two machine core end plates, and a machine core lid mounted at a top portion of said two machine core side plates and said two machine core end plates, wherein said two machine core side plates and said two machine core end plates are connected side by side to form four side walls of the machine core;
wherein said machine core lid has a machine core lid side plate and a machine core lid end plate arranged thereon, wherein a side of said machine core lid side plate is hingedly jointed with one of said machine core side plate through a hinge, wherein said machine core lid end plate has a machine core lock sliding groove penetratedly formed therein, wherein a fourth machine core lock rod, which is slidably assembled in said machine core lock sliding groove, penetrates through two sides of said machine core lock sliding groove to be assembled and affixed with a machine core lock limiting ring respectively;
wherein said fourth machine core lock rod is further assembled and affixed with an end of a first machine core lock plate, wherein another end of said first machine core lock plate is hingedly jointed with said machine core end plate through a third machine core lock rod, wherein said third machine core lock rod is positioned away from a side of a hinge joint of said third machine core lock rod and said machine core lid;
wherein said core lid end plate is further hinged to an end of a second machine core lock plate through a second machine core lock shaft, wherein another end of said second machine core lock plate has a machine core lock groove, wherein a first machine core lock rod is coupled and assembled in said machine core lock groove, wherein said first machine core lock rod is affixed on said machine core end plate;
wherein said second machine core lock plate is further assembled and affixed with an end of a machine core extension spring, wherein another end of said machine core extension spring is assembled and affixed with a fifth machine core lock rod, wherein said fifth machine core lock rod is affixed on said core lid end plate;
wherein said manipulator comprises:
a first support arm, a second support arm, a third support arm, a first arm claw, and a second arm claw, wherein said first support arm is configured to drive said second support arm and said third support arm to move in a length direction thereof, wherein said second support arm is adapted to drive said third support arm to move in a length direction thereof, wherein said first arm claw and said second arm claw are respectively installed on said third support arm;
wherein said first support arm comprises a first supporting arm cover mounted at a top thereof, a supporting arm bottom plate mounted at a bottom thereof, and a supporting arm reinforcing plate affixed between a top side of said supporting arm bottom plate and a side face of said first support arm, wherein said supporting arm bottom plate comprises a traveling motor affixed thereon, wherein a traveling output shaft of said traveling motor penetrates out of said supporting arm bottom plate to be assembled and affixed with a traveling gear, wherein said supporting arm sliding block is engaged and slidably assembled with said sliding rail, wherein said traveling gear is meshed with a traveling rack affixed on said sliding rail mounting plate so as to form a gear rack transmission mechanism;
wherein said first support arm comprises a circumferentially rotatable first support arm screw rod mounted therein, wherein an end of said first supporting arm screw rod is rotatably assembled with said supporting arm bottom plate, and another end of said first supporting arm screw rod penetrates out of said first supporting arm to enter said first supporting arm cover to be assembled and affixed with a first second supporting arm belt pulley, wherein said first second supporting arm belt pulley is connected with a first first supporting arm belt pulley through a first supporting arm belt so as to form a first belt transmission mechanism, wherein said first first supporting arm belt pulley is mounted on an output shaft of a supporting arm lifting motor, wherein said supporting arm lifting motor is affixed on said first supporting arm, wherein said first support arm screw rod and a supporting arm lifting sliding plate are assembled through threads, wherein said supporting arm lifting sliding plate is engaged and vertical slidably assembled with said first supporting arm;
wherein said second support arm is affixed on said supporting arm lifting sliding plate, wherein said second support arm comprises a second support arm cover mounted on an end thereof and a second support arm screw rod mounted inside thereof, wherein an end of said second support arm screw rod is rotatably assembled in said second support arm with the end thereof away from said second support arm cover, while another end of said second support arm screw rod penetrates out of said second support arm cover to enter said second support arm cover to be assembled and affixed with a second first support arm belt pulley, wherein said second first belt pulley is connected with said second first support arm belt pulley through a second support arm belt to form a second belt transmission mechanism, wherein said second first supporting arm belt pulley is mounted on an output shaft of a supporting arm lateral movement motor, wherein said supporting arm lateral movement motor is affixed on said second supporting arm;
wherein said second support arm screw rod and a supporting arm lateral movement sliding plate are assembled through threads, wherein said supporting arm lateral movement sliding plate is coupled and slidably assembled with the outer wall of said second supporting arm, wherein said supporting arm lateral movement sliding plate comprises a supporting arm hinge frame affixed thereon;
wherein said supporting arm hinge frame comprises a supporting arm rotating motor installed thereon, wherein an output shaft of the supporting arm rotating motor is assembled and affixed with an end of said second arm claw and said third supporting arm through a coupler and a supporting arm hinge shaft, wherein said third support arm comprises a third supporting arm screw rod mounted inside thereof, wherein an end of said third supporting arm screw rod is rotatably assembled with said second arm claw, while another end of said third supporting arm screw rod passes through said third supporting arm to enter a third supporting arm cover to be assembled and affixed with a third second supporting arm belt pulley, wherein said third supporting arm cover is mounted on said third supporting arm and said third second supporting arm belt pulley is connected with a third first supporting arm belt pulley through a third supporting arm belt so as to form a third belt transmission mechanism, wherein said third first supporting arm belt pulley is affixed on the output shaft of a clamping motor, wherein said clamping motor is affixed on said third supporting arm, wherein said third supporting arm screw rod and an end of said first arm claw are screwed and assembled, wherein the end of said first arm claw is buckled in an adjustment sliding groove of said third support arm.
